(19) United States
(12) Patent Application Publication
(10) Pub. No.: US 2007/0212633 A1
(43) Pub. Date: Sep. 13, 2007

(54) Method for Producing Negatively Chargeable Toner

(75) Inventor: Toshiaki YAMAGAMI, Shiojiri-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 11/685,104

(22) Filed: Mar. 12, 2007

(30) Foreign Application Priority Data
Mar. 13, 2006 (JP) 2006-066955

(51) Int. Cl. G03G 9/08

(52) U.S. Cl. 430/137.14

(57) ABSTRACT

A method for producing negatively chargeable toner includes adding a plurality of external-additive fine particles to base toner particles in multiple steps with a spherical mixer, the base toner particles being formed by subjecting a mixture containing at least a resin and an organic solvent to phase inverse emulsification in an aqueous medium, coalescing, washing, dehydrating, and drying the resulting particles, wherein the dry base toner particles have an organic solvent content of 200 to 1,000 ppm, 0.1 to 3.0 mass % of the external-additive fine particles having an average particle size of 30 to 50 nm are added, and the base toner particles have an average degree of circularity of 0.94 to 0.99.

### BACKGROUND

1. Technical Field

The present invention relates to a method for producing negatively chargeable toner for use in electrophotography, electrostatic recording, electrostatic printing, and the like.

2. Related Art

In electrophotography, an electrostatic latent image formed on a latent image carrier provided with a photoconductive material is developed with colorant-containing toner particles. Then, the resulting toner image is transferred onto an intermediate transfer medium. The transferred toner image is further transferred onto a recording medium, such as paper, and fixed by heat, pressure, or the like, thereby forming a copy or printed matter. For example, to improve the quality of the printed image of the printed matter, to reduce the cost, the size, and the power consumption of equipment, to achieve resource savings, requirements for toner are as follows: (1) the improvement of the resolution and the gray scale of the printed image by reducing the particle size of toner, a reduction in the thickness of a toner layer, a reduction in the amount of waste toner, and a reduction in toner consumption per page; (2) a reduction in power consumption by reducing fixing temperature; (3) the simplification of a fuser by oilless fusing;(4) the improvement of hue, transparency, and gloss in a full-color image; and (5) a reduction in the amount of a harmful volatile organic compound generated during fixing of toner.

The particle size of powder toner can also be reduced by a traditional grinding method. However, as the particle size is reduced, the following problems occur: For example, difficulty in the control of charging because of an increase in ratios of a colorant and a release agent such as wax that are exposed at surfaces of toner particles; the degradation of powder flowability because of irregular-shaped toner particles; and an increase in energy cost of production. Thus, toner produced by the grinding method is practically difficult to sufficiently satisfy the requirements.

In this situations, toner (hereinafter, referred to as “chemical toner”) produced by polymerization or emulsification has been actively developed because of the circumstances. Various methods for producing toner by polymerization are known. Among them, suspension polymerization for forming toner particles by adding a monomer, a polymerization initiator, a colorant, a charge control agent, and the like to an aqueous medium under stirring in the presence of a dispersion stabilizer to form oil droplets and then heating the resulting mixture to perform a polymerization reaction is widely known. Furthermore, an aggregation method for forming toner particles by forming fine particles by emulsion polymerization or suspension polymerization, aggregating the fine particles, and fusing the fine particles is also reported. In the polymerization method or the aggregation method using fine particles formed by a polymerization method, a reduction in the particle size of toner is achieved without problems. However, toner composed of a polyester resin or an epoxy resin, which is suitable for color toner, cannot be produced because the main component of a binder resin is limited to a radically polymerizable vinyl polymer. Furthermore, in the polymerization method, it is disadvantageously difficult to reduce the amount of a volatile organic compound (VOC) such as an unreacted monomer. It is desirable to reduce the VOC.

On the other hand, a method for producing toner by emulsification is a method for obtaining toner particles by emulsifying an organic solvent solution containing a binder resin, a colorant, and the like in an aqueous medium. As with the case with polymerization, a reduction in the particle size of toner and the conglobation of each of the toner particles can be easily achieved by emulsification. Emulsification has advantages that the range of choice of types of binder resin is wide; the content of a residual monomer is easily reduced; and the concentration of the colorant or the like can be desirably changed, compared with polymerization. A binder resin for use in toner that has a relatively low fixing temperature and that readily melts to easily flatten the surface of an image during fixing is preferably a polyester resin rather than a styrene-acrylic resin. In particular, a binder resin for use in a color toner is preferably a polyester resin having a satisfactory flexibility. However, in the polymerization, toner particles containing a binder resin mainly composed of a polyester resin cannot be produced. Accordingly, in recent years, a method for producing toner having a small particle size and containing a polyester resin as a binder resin by emulsification has been receiving attention.

Examples of the method for producing toner having a small particle size and containing a polyester resin as a binder resin include (1) a method for producing toner particles by performing emulsification with a polyester resin as a binder resin, aggregating the resulting fine particles, and fusing the aggregated particles by heating to form aggregates, i.e., the method for producing toner particles by aggregation, the method including two successive steps: the aggregating step and the fusing step; and (2) a method for producing toner particles by forming fine particles by emulsification, and performing a step of aggregating the fine particles and a step of fusing the aggregated particles at the same time, i.e., the method for producing toner particles by coalescence, the method including a single step of simultaneously aggregating and fusing fine particles formed by emulsification. It is known that spherical toner particles can be simply produced for a short period of time according to the latter production method by coalescence.

For example, JP-A-2003-122051 discloses that when the addition of a dispersion stabilizer and an electrolyte after a mixture containing a polyester resin and the like is emulsified to form a dispersion, coalescence process can be stable performed to form chemical toner having a narrow particle size distribution without loss of emulsification. Furthermore, the chemical toner can be simply obtained for a short period of time in high yield. JP-A-8-71405 discloses that a mixed composition containing an organic solvent, a colorant, and an anionic self-water dispersible resin, such as an acrylic resin, a styrene resin, or a polyester resin that has an acidic group neutralized with a basic material, is subjected to phase inversion emulsification in an aqueous medium to form anionic self-water dispersible resin particles having the encapsulated colorant in the aqueous medium.

However, the resulting base toner particles obtained by phase inversion emulsification have the following disadvantages: the inclusion of water and the solvent causes blocking, the deformation of substantially spherical base toner particles obtained by phase inversion emulsification, and an increase in the number of agglomerates even after drying. Furthermore, in the case of a core-shell structure, an increase in the number of free fine particles by destruction of the structure results in the nonuniformity of toner properties. Moreover, when the resulting toner is used to produce many printed sheets, the amount of charge is reduced after endurance printing. That is, only the toner with poor durability is obtained. In addition, a reduction in the amount of the charge of toner disadvantageously results in the detachment of toner from a development roller to cause the nonuniformity of the amount of toner transferred, thereby resulting in the nonuniformity of a printed image.

Thus, freeze drying (JP-A-8-71405) and vacuum drying for a polymerized toner (JP-A-8-160662) are employed in a step of drying toner. Furthermore, JP-A-11-295927 discloses that a step of drying toner with stirring using a Riboone or a Nauta mixer under reduced pressure while a gas is fed is employed. However, any of these methods has insufficient productivity. JP-A-9-106093 and JP-A-9-106096 disclose that the shape of toner particles is modified by forming base toner particles into blocks, adding organic or inorganic fine particles thereinto, mixing the resulting mixture, and disintegrating the blocks. However, these methods do not solve the problems with the base toner particles obtained by phase inversion emulsification.

### SUMMARY

An advantage of some aspects of the invention is that in a method for producing negatively chargeable toner composed of base toner particles formed by subjecting a mixture containing at least a resin and an organic solvent to phase inverse emulsification in an aqueous medium, coalescing, washing, dehydrating, and drying the resulting particles, the method for producing high-durability negatively chargeable toner having excellent flowability and excellent charge stability in producing many printed sheets without a nonuniform printed image is provided.

A method according to an aspect of the invention for producing negatively chargeable toner includes adding a plurality of external-additive fine particles to base toner particles in multiple steps with a spherical mixer, the base toner particles being formed by subjecting a mixture containing at least a resin and an organic solvent to phase inverse emulsification in an aqueous medium, coalescing, washing, dehydrating, and drying the resulting particles. The dry base toner particles have an organic solvent content of 200 to 1,000 ppm, 0.1 to 3.0 mass % of the external-additive fine particles having an average particle size of 30 to 50 nm are added thereto, and the base toner particles have an average degree of circularity of 0.94 to 0.99.

### BRIEF DESCRIPTION OF THE DRAWINGS

The invention will be described with reference to the accompanying drawings, wherein like numbers reference like elements.

FIG. 1A is a cross-sectional view through the center of a spherical mixer.

FIG. 2 is a plan view of an example of a mixing blade.

FIG. 3 is a plan view of a Henschel mixer.

### DESCRIPTION OF EXEMPLARY EMBODIMENTS

Base toner particles according to an aspect of the invention are obtained by subjecting a mixture containing at least a resin and an organic solvent to phase inverse emulsification in an aqueous medium without loss of emulsification and have a narrow particle size distribution. Negatively chargeable toner is produced by adding a predetermined amount of some of additive particles, which are used in the subsequent adding step, each having a predetermined particle size to a wet base toner particles having a predetermined residual solvent content and drying the resulting particles. The resulting negatively chargeable toner has excellent flowability without agglomeration and prevents a reduction in the amount of charge after endurance printing.

The base toner particles according to an aspect of the invention are formed by subjecting a mixture containing at least a resin and an organic solvent to inverse emulsification in an aqueous medium, coalescing, washing, dehydrating, and drying the resulting particles. For example, the base toner particles are obtained by (1) a method described in Patent Document 1 or (2) a method described in Patent Document 2. The method described in Patent Document 1 includes a step of emulsifying a mixture containing at least a polyester resin and an organic solvent in an aqueous medium to form fine particles; and a step of adding a dispersion stabilizer and then an electrolyte thereto to allow the fine particles to coalesce and to form aggregates. Patent Document 2 describes the method in which a mixed composition containing an organic solvent, a colorant, and an anionic self-water dispersible resin, such as an acrylic resin or a polyester resin that has an acidic group neutralized with a basic material, is subjected to phase inversion emulsification in an aqueous medium to form base toner particles composed of anionic self-water dispersible resin particles having the encapsulated colorant in the aqueous medium.

The base toner particles according to an aspect of the invention are produced by removing the organic solvent contained in the base toner particles obtained by the method (1) or (2) by distillation under reduced pressure or through washing and dehydrating steps, removing fine particles from the aqueous medium by centrifugation to form wet fine particles (cake), adding 0.1 to 3.0 mass % of external-additive fine particles having an average particle size of 30 to 50 nm to uniformly attach the external-additive fine particles onto surfaces of the wet fine particles, and drying the resulting particles with stirring under reduced pressure.

The base toner particles produced by the method (1) will be described below as an example of the base toner particles according to an aspect of the invention. Alternatively, the base toner particles produced by the method (2) may also be used. The base toner particles according to an aspect of the invention are not particularly limited.

A polyester resin in the base toner particles produced by the method (1) is prepared by dehydration condensation of a polybasic acid and a polyhydric alcohol. Examples of the polybasic acid include aromatic carboxylic acids, such as terephthalic acid, isophthalic acid, phthalic anhydride, trimellitic acid anhydride, pyromellitic acid, and naphthalenedicarboxylic acid; aliphatic carboxylic acids, such as maleic anhydride, fumaric acid, succinic acid, an alkenylsuccinic anhydride, and adipic acid; and alicyclic carboxylic acids such as cyclohexanedicarboxylic acid. These polybasic acids may be used alone or in combination. Among these polybasic acids, an aromatic carboxylic acid is preferably used.

Examples of polyhydric alcohol include aliphatic diols, such as ethylene glycol, diethylene glycol, triethylene glycol, propylene glycol, butanediol, hexanediol, neopentyl glycol, glycerol, trimethylolpropane, and pentaerythritol; alicyclic diols, such as cyclohexanediol, cyclohexanedimethanol, and hydrogenated bisphenol A; and aromatic diols, such as an ethylene oxide adduct of bisphenol A and an propylene oxide adduct of bisphenol A. These polyhydric alcohols may be used alone or in combination. Among these polyhydric alcohols, aromatic diols and alicyclic diols are preferred. Aromatic diols are more preferred.

A monocarboxylic acid and/or a monoalcohol may be added to a polyester resin obtained by condensation polymerization of a polycarboxylic acid and a polyhydric alcohol to esterify a terminal hydroxyl group and/or a carboxyl group and to adjust the acid value of the polyester resin. Examples of the monocarboxylic acid used for this purpose include acetic acid, acetic anhydride, benzoic acid, trichloroacetic acid, trifluoroacetic acid, and propionic anhydride. Examples of the monoalcohol include methanol, ethanol, propanol, octanol, 2-ethylhexanol, trifluoroethanol, trichloroethanol, hexafluoroisopropanol, and phenol.

The polyester resin may be prepared by condensation reaction of the polyhydric alcohol and the polycarboxylic acid in the usual manner. For example, the polyhydric alcohol and the polycarboxylic acid are placed in a reaction vessel equipped with a thermometer, a stirrer, a condenser and heated to 150° C. to 250° C. in the presence of an inert gas such as a nitrogen gas. A by-product low-molecular-weight compound is continuously removed from the reaction system. The reaction is terminated when a predetermined value of a physical property is achieved. The reaction system is cooled to obtain a target product.

The polyester resin may be prepared in the presence of a catalyst. Examples of an esterification catalyst include organometallic compounds, such as dibutyltin dilaurate and dibutyltin oxide; and metal alkoxides such as tetrabutyltitanate. In the case where a carboxylic component used is a lower alkyl ester, an ester interchange catalyst may be used. Examples of the ester interchange catalyst include metal acetates, such as zinc acetate, lead acetate, and magnesium acetate; metal oxides, such as zinc oxide and antimony oxide; and metal alkoxides such as tetrabutyltitanate. The amount of the catalyst added is preferably in the range of 0.01 to 1 mass % for the total amount of starting materials.

In the condensation polymerization, in particular, to prepare a branched or crosslinked polyester resin, a polybasic acid having at least three carboxylic groups per molecule or anhydride thereof and/or a polyhydric alcohol having at least three hydroxyl groups per molecule may be used as an essential synthetic raw material.

The polyester resin preferably has the following properties when measured with a constant-load extrusion type capillary rheometer (hereinafter, referred to as a “flow tester”) in order that toner for use in a heat roller fixation system has a satisfactory fixing/offset temperature range. That is, in measurement with the flow tester, the flow beginning temperature (Tfb) is in the range of 80° C. to 120° C., the T1/2 temperature is in the range of 100° C. to 160° C., and the flow ending temperature (Tend) is in the range of 110° C. to 210° C. The use of a polyester resin having such values measured with the flow tester results in satisfactory oilless fixing-properties. Furthermore, the glass transition temperature (Tg) is preferably in the range of 40° C. to 75° C.

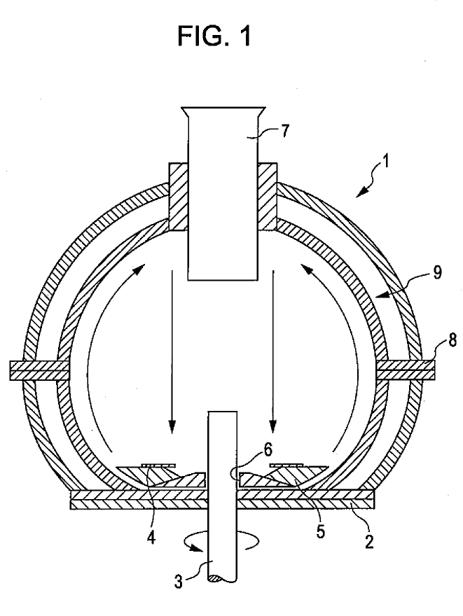

The flow beginning temperature (Tfb), the T1/2 temperature, and the flow ending temperature (Tend) are determined with a flow tester (Model: CFT-500, manufactured by Shimadzu Corporation). As shown in FIG. 1(a) described in JP-A-2003-122051, this flow tester include a cylinder 2 provided with a nozzle 1 having a diameter D of 1.0 mm and a nozzle length (depth) L of 1.0 mm. A resin 3 (1.5 g) is charged into the cylinder 2. The stroke S of a loading surface 4 (displacement of the loading surface 4) is measured at a heating rate of 6° C./min while a load of 10 kg per unit area (cm²) is applied to the loading surface 4 from the side opposite the nozzle 1, thereby determining the flow beginning temperature (Tfb), the T1/2 temperature, and the flow ending temperature (Tend). That is, the relationship between the heating temperature and the stroke S is determined as shown in FIG. 1(b) described in JP-A-2003-122051. When the resin 3 starts to flow from the nozzle 1, the stroke S steeply increases. The temperature at the leading edge of the curve is defined as Tfb. The temperature at the trailing edge of the curve after completion of the flow of the resin 3 from the nozzle 1 is defined as Tend. The temperature at the intermediate value S1/2 lying between the stroke Sfb at Tfb and the stroke send at Tend is defined as T1/2 temperature. In the programmed temperature measurement with this apparatus, the test is performed at a constant heating rate with time. Thus, a process from a solid region to a flow region of a sample through a transition region, an elastomeric region can be continuously measured. This apparatus can simply measure the rate of shear and viscosity in the flow region at any temperature.

The flow beginning temperature Tfb serves as an index of the sharp-melting property and the low-temperature fixing property of a polyester resin. An excessively high temperature degrades the low-temperature fixing property, thus easily causing a cold offset. An excessively low temperature degrades storage stability, thus easily causing a hot offset. Hence, the flow beginning temperature Tfb is preferably in the range of 90° C. to 115° C. and more preferably 90° C. to 110° C.

The melting temperature T1/2 of toner determined by a ½ method and the flow ending temperature Tend each serve as an index of anti-hot offset properties. In each case, an excessively high temperature increases solution viscosity, thus degrading the particle size distribution during the formation of particles. At an excessively low temperature, an offset occurs easily to degrade practicality. Thus, the melting temperature T1/2 in accordance with the ½ method needs to be in the range of 120° C. to 160° C. and preferably 130° C. to 160° C. The flow ending temperature Tend is preferably in the range of 130° C. to 210° C. and more preferably 130° C. to 180° C. When Tfb, T1/2, and Tend are set within the ranges, toner can be fixed in a wide temperature range.

The polyester resin contains a crosslinked polyester resin. The tetrahydrofuran-insoluble content of the binder resin is in the range of 0.1 to 20 mass %, preferably 0.2 to 10 mass %, and more preferably 0.2 to 6 mass %. The binder resin is preferably a polyester resin having a tetrahydrofuran-insoluble content of 0.1 to 20 mass % because satisfactory anti-hot offset properties are ensured. A tetrahydrofuran-insoluble content of less than 0.1 mass % results in the lack of the effect of improving the anti-hot offset properties, which is not preferred. A tetrahydrofuran-insoluble content exceeding 20 mass % results in excessively high solution viscosity, thus increasing the fixing initiation temperature. This throws fixing off balance and thus is not preferred. Furthermore, this impairs the sharp-melting property to degrade transparency, color reproducibility, and gloss in a color image, which is not preferred.

The tetrahydrofuran-insoluble component of the binder resin is determined as follows: 1 g of the resin is weighed accurately and added to 40 mL of tetrahydrofuran. A soluble component is completely dissolved. The resulting mixture is filtered through 2 g of Radiolite (#700, manufactured by Showa Chemical Industry Co., Ltd.) uniformly placed on Kiriyama filter paper (No. 3) in a filter funnel (diameter: 40 mm). The resulting cake is placed on an aluminum dish and dried at 140° C. for 1 hour. The resulting dry cake is weighed. The weight of the residual resin remaining in the dry cake is divided by the initial weight of the resin to express the resulting value in percentage. This value is defined as the tetrahydrofuran-insoluble content of the binder resin.

More preferably, the binder resin contains a high-viscosity crosslinked polyester resin and a branched or linear polyester resin having a low viscosity. That is, in the polyester resin according to an aspect of the invention, the binder resin may be composed of a single type of polyester resin. Alternatively, in general, the binder resin containing a high-viscosity crosslinked polyester resin having a high molecular weight and a low-viscosity branched or linear polyester resin having a low molecular weight is practical and preferred in view of the production of the resin and in order to achieve a satisfactory fixing initiation temperature and satisfactory anti-hot offset properties. In the case of the binder resin containing the crosslinked polyester resin and the branched or linear polyester resin, values of the binder resin measured with the flow tester may be within the above-described ranges. In an aspect of the invention, the crosslinked polyester resin refers to a resin containing the tetrahydrofuran-insoluble component. The branched or linear polyester resin refers to a resin soluble in tetrahydrofuran and having no gel component determined from the measurement of the gel component.

In an aspect of the invention, a plurality of polyester resins having different melt viscosities may be used as the binder resin. For example, in the case where a mixture of a branched or linear polyester resin having a low viscosity and a high-viscosity crosslinked polyester resin is used. It is preferable that a mixture of a branched or linear polyester-resin (A) and a crosslinked or branched polyester resin (B) that satisfy the following requirements is used. In this case, melt viscosities and amounts of the resins (A) and (B) are appropriately adjusted in such a manner that values of the mixture measured with the flow tester are within the above-described ranges.

That is, the polyester resin (A) is a branched or linear polyester resin having a T1/2 temperature measured with the flow tester of 80° C. or more and less than 120° C. and a glass transition temperature Tg of 35° C. to 70° C. The polyester resin (B) is a crosslinked or branched polyester resin having a T1/2 temperature measured with the flow tester of 120° C. to 210° C. and a glass transition temperature Tg of 50° C. to 75° C. The ratio by weight of the polyester resin (A) to the polyester resin (B), i.e., (A)/(B), is in the range of 20/80 to 80/20. The T1/2 temperatures of the polyester resin (A) and the polyester resin (B) are defined as T1/2(A) and T1/2(B), respectively. The polyester resin (A) and the polyester resin (B) that satisfy the relationship 20° C.<T1/2(B)−T1/2(A)<100° C. are preferably used.

Regarding the temperature properties measured with the flow tester, the melting temperature T1/2(A) of the polyester resin (A) measured by the ½ method serves as an index for the impartation of the sharp-melting property and the low-temperature fixing property. The melting temperature T1/2(A) is more preferably in the range of 80° C. to 115° C. and particularly preferably 90° C. to 110° C.

The polyester resin (A) specified by these properties has a low softening temperature. In a fixing process with a heat roller, even when thermal energy is reduced because of a reduction in the temperature of the heat roller and an increase in process speed, the polyester resin (A) melts sufficiently and exerts satisfactory anti-cold offset properties and a satisfactory low-temperature fixing property.

In the case where each of the melting temperature T1/2(B) measured by the ½ method and the flow ending temperature Tend(B) of the polyester resin (B) is excessively low, the hot offset occurs easily. In the case where each of the melting temperature T1/2(B) and the flow ending temperature Tend(B) is excessively high, a particle size distribution during the formation of particles is degraded to reduce productivity. Consequently, T1/2(B) is more preferably in the range of 125° C. to 210° C. and particularly preferably 130° C. to 200° C.

The polyester resin (B) specified by these properties tends to be elastomeric and has high melt viscosity. The internal cohesive force of a melted toner layer is maintained during a heating and melting step in a fixing process. Thus, hot offset does not easily occur. After fixing, the polyester resin (B) is tough and thus exerts satisfactory abrasion resistance.

A well-balanced mixing of the resin (A) and the resin (B) provides toner that sufficiently satisfies the anti-offset properties in a wide temperature range and the low-temperature fixing property. An excessively low ratio by weight of the resin (A) to the resin (B), i.e., (A)/(B), adversely affects the fixing property. An excessively high ratio adversely affects the anti-offset properties. Consequently, the ratio is preferably in the range of 20/80 to 80/20 and more preferably 30/70 to 70/30.

Melting temperatures of the resin (A) and the resin (B) measured by the ½ method are defined as T1/2(A) and T1/2(B), respectively. In view of a balance between the low-temperature fixing property and the anti-offset properties and in order to uniformly mixing the mixture without problems due to the difference in viscosity between the resins, T1/2(B)−T1/2(A) is more preferably above 20° C. and 90° C. or less and particularly preferably above 20° C. and 80° C. or less.

The glass transition temperature (Tg) is a value measured at a heating rate of 10° C. per minute by a second-run method with a differential scanning calorimeter (DSC) manufactured by Shimadzu Corporation. When the polyester resin (A) has a Tg of less than 35° C. or when the polyester resin (B) has a Tg of less than 50° C., the resulting toner tends to cause blocking (a phenomenon in which toner particles are aggregated to form agglomerates) during storage or in a developing apparatus, which is not preferred. On the other hand, when the polyester resin (A) has a Tg exceeding 70° C. or when the polyester resin (B) has a Tg exceeding 75° C., the fixing temperature of the toner increases, which is not preferred. When the polyester resin (A) and the polyester resin (B) that satisfy the above-described relationship and serve as the binder resin are used, the resulting toner has more satisfactory fixation, which is preferred.

To provide satisfactory fixation, the binder resin composed of the polyester resin preferably satisfies all of the following requirements: the weight-average molecular weight is 30,000 or more and preferably 37,000 or more; the (weight-average molecular weight (Mw))/(number-average molecular weight (Mn)) is 12 or more and preferably 15 or more; the area ratio of a component having a molecular weight of 600,000 to the total is 0.3% or more and preferably 0.5% or more; and the area ratio of a component having a molecular weight of 10,000 or less is in the range of 20% to 80% and preferably in the range of 30% to 70%, in the measurement of the molecular weight by gel permeation chromatography (GPC) of the tetrahydrofuran-soluble fraction (THF-soluble fraction). In the case of the binder resin containing a plurality of resins, measurements of a final resin mixture in the measurement by GPC may satisfy the above-described ranges.

In the polyester resin according to an aspect of the invention, a high-molecular weight component having a molecular weight of 600,000 or higher is effective in ensuring the anti-hot offset properties. On the other hand, a low-molecular weight component having a molecular weight of 10,000 or less is effective in reducing the melt viscosity of the resin, thereby attaining sharp melting properties and reducing the fixing initiation temperature. Thus, the polyester resin preferably contains the resin component having a molecular weight of 10,000 or less. To obtain satisfactory thermal properties, such as fixation at low temperatures, anti-hot offset properties, and transparency, in an oilless fixing system, the binder resin preferably has such a broad molecular weight distribution.

The molecular weight of the THF-soluble fraction in the binder resin is determined in the following manner. That is, the THF-soluble fraction is collected by filtering through a filter (0.2 μm) and then measured in a THF solvent (flow rate: 0.6 mL/min, temperature: 40° C.) with GPC-HLC-8120 produced by Tosoh Corporation and three columns “TSKgel Super HM-M” (15 cm) produced by Tosoh Corporation. Then, the molecular weight is calculated by means of a molecular weight calibration curve made using a monodisperse polystyrene standard sample.

The acid value (mg of KOH required to neutralize 1 g of a resin) of the polyester resin is preferably within a range of 1 to 20 mg KOH/g from the reasons as follows: the above-described molecular weight distribution is easily obtained; the formation properties of the fine particles by emulsification is easily ensured; and satisfactory environmental stability (stability of charge properties when the temperature and humidity change) of the resulting toner is easily retained. The acid value of the polyester resin can be adjusted by controlling a terminal carboxyl group of the polyester resin by means of the mixing ratio and the reaction rate of the polybasic acid and the polyhydric alcohol as the starting materials, as well as the addition of the monocarboxylic acid and/or the monoalcohol to the polyester resin obtained by the condensation polymerization between the polyhydric carboxylic acid and the polyhydric alcohol, as described above. Alternatively, a polyester having a carboxyl group in the main chain can be prepared with trimellitic anhydride as the polybasic acid component.

The base toner particles may contain a releasing agent. The releasing agent is selected from the group consisting of hydrocarbon waxes such as polypropylene wax, polyethylene wax, and Fischer-Tropsch wax; synthetic ester waxes; and natural ester waxes such as carnauba wax and rice wax. Among these, natural waxes such as carnauba wax and rice wax, and synthetic ester waxes obtained from a polyhydric alcohol and a long-chain monocarboxylic acid are preferably used. An example of the synthetic ester wax suitably used is WEP-5 (produced by NOF Corporation). When the content of the releasing agent is less than 1 mass %, releasability is liable to be insufficient. When the content exceeds 40 mass %, the wax is liable to be exposed at surfaces of the toner particles, thereby degrading the charge properties and storage stability. Therefore, the content of the releasing agent is preferably in the range of 1 to 40 mass %.

The base toner particles may contain a charge control agent. Examples of a negative charge control agent include heavy-metal-containing acid dye, such as trimethylethane dye, metal complex salts of salicylic acid, metal complex salts of benzilic acid, copper phthalocyanine, perylene, quinacridone, azo dye, azo dye of metal complex salts, and azochromium complexes; calixarene type phenolic condensates, cyclic polysaccharide, and carboxyl- or sulfonyl-group-containing resins. The content of the charge control agent is preferably in the range of 0.01 to 10 mass % and particularly preferably 0.1 to 6 mass %.

The colorant is not particularly limited. Known colorants may be used. In particular, a pigment is suitably used, Examples of black pigments include carbon black, cyanine black, aniline black, ferrite, and magnetite. Alternatively, black pigments prepared from the following color pigments may be used.

Examples of yellow pigments include Chrome Yellow, Zinc Yellow, Cadmium Yellow, Yellow Iron Oxide, ocher, titanium yellow, Naphthol Yellow S, Hansa Yellow 10G, Hansa Yellow 5G, Hansa Yellow G, Hansa Yellow GR, Hansa Yellow A, Hansa Yellow RN, Hansa Yellow R, Pigment Yellow L, Benzidine Yellow, Benzidine Yellow G, Benzidine Yellow CR, Permanent Yellow NCG, Vulcan Fast Yellow SC, Vulcan Fast Yellow R, Quinoline Yellow Lake, Anthragen Yellow 6GL, Permanent Yellow FGL, Permanent Yellow H10G, Permanent Yellow HR, Anthrapyrimidine Yellow, Isoindolinone Yellow, Cromophthal Yellow, Nobopalm Yellow H2G, Condensed Azo Yellow, Nickel Azo Yellow, and Copper Azomethin Yellow.

Examples of red pigment include Chrome Orange, Molybdenum Orange, Permanent Orange GTR, Pyrazolone Orange, Valcan Orange, Indathrene Brilliant Orange RK, Indathrene Brillant orange G, Benzidine Orange G, Permanent Red 4R, Permanent Red BL, Permanent Red F5RK, Lithol Red, Pyrazolone Red, Watchung Red, Lake Red C, Lake Red D, Brilliant Carmine 6B, Brilliant Carmine 3B, Rhodamine Lake B, Arisaline Lake, Permanent Carmine FBB, Perinone Orange, Isoindolinone Orange, Anthanthrone Orange, Pyranthrone Orange, Quinacridone Red, Quinacridone Magenta, Quinacridone Scarlet, and Perylene Red.

Examples of blue pigment include Cobalt Blue, Cerulean Blue, Alkaline Blue Lake, Peacock Blue Lake, Phanatone Blue 6G, Victoria Blue Lake, Metal-free Phthalocyanine Blue, Copper Phthalocyanine Blue, Fast Sky Blue, Indanthrene Blue RS, Indanthrene Blue BC, and Indigo.

The amount of the colorant used is preferably in the range of 1 to 50 parts by mass and particularly preferably 2 to 15 parts by mass per 100 parts by mass of the binder resin.

A method for producing the base toner particles will be described below. In a first step, the polyester resin is added to an organic solvent and dissolved (by heating, if necessary) to prepare a mixture containing the polyester resin and the organic solvent. In this case, as a material for the toner, at least one selected from the colorants, the releasing agents, charge control agents, and other additives may be used together with the polyester resin. In an aspect of the invention, the colorant is preferably dispersed in the organic solvent containing the polyester resin. Similarly, the additives, such as the releasing agent and the charge control agent, are particularly preferably dissolved or dispersed in the organic solvent.

As a method for dissolving or dispersing the polyester resin and, if necessary, the additives, such as the colorant, the releasing agent, and the charge control agent, in the organic solvent, the following method is preferably employed: A mixture containing the polyester resin and the additives, such as the colorant, the releasing agent, and the charge control agent, is kneaded at a temperature in the range of the softening temperature to the decomposition temperature with a pressure kneader, a heated twin roll, a twin-screw extruder, or the like. For example, the colorant may be melt-kneaded as a master batch. The resulting kneaded chips are dissolved or dispersed in the organic solvent with a stirrer such as a Despa. Alternatively, the polyester resin and the additives, such as the colorant, the releasing agent, and the charge control agent, are mixed with the organic solvent. The resulting mixture is wet-kneaded with a ball mill or the like. In this case, the colorant, the releasing agent, and the like may be separately preliminarily dispersed in advance.

More specifically, there is provided a method for producing a resin solution containing the colorant, the releasing agent, and the like finely dispersed in the organic solvent by placing a resin solution containing the polyester resin dissolved in the organic solvent, the colorant, and the releasing agent into a mixing/dispersing apparatus such as a ball mill, a bead mill, a sand mill, a continuous bead mill, or the like using grinding media, stirring and dispersing the mixture to form a master batch, and mixing the polyester resin for dilution and the additional organic solvent. In this case, a master batch prepared by kneading and dispersing the low-viscosity polyester resin and the additives, such as the colorant and the releasing agent, with a pressure kneader or a heated twin roll in advance is preferably used rather than placing the additives, such as the colorant and the releasing agent, into the mixing/dispersing apparatus such as a ball mill without any treatment. The production method is preferred because the polymeric component (gel component) of the polyester resin is not cleaved, as compared with a dispersing method by melt-kneading.

Examples of the organic solvent for dissolving or dispersing the polyester resin and, if necessary, the colorant, the releasing agent, and the like include hydrocarbons, such as pentane, hexane, heptane, benzene, toluene, xylene, cyclohexane, and petroleum ether; halogenated hydrocarbons, such as methylene chloride, chloroform, dichloroethane, dichloroethylene, trichloroethane, trichloroethylene, and carbon tetrachloride; ketones, such as acetone, methyl ethyl ketone, and methyl isobutyl ketone; and esters, such as ethyl acetate and butyl acetate. These solvents may be used alone or a mixture of two or more. In view of the recovery of the solvent, a single type of solvent is preferably used. The organic solvent capable of dissolving the binder resin, having relatively low toxicity, and a low boiling point is preferred, the organic solvent being easily removed in the subsequent step. Methyl ethyl ketone is most preferred,

As a method for emulsifying the mixture containing the polyester resin and the organic solvent with an aqueous medium, the mixture containing the polyester resin, the organic solvent, and, if necessary, the colorant and the like and prepared by the above-described method is preferably mixed and emulsified with the aqueous medium in the presence of a basic neutralizer. In this step, a method of gradually adding the aqueous medium (water or a liquid medium mainly composed of water) to the mixture containing the polyester resin, the organic solvent, the colorant, and the like is preferred. In this case, gradual addition of water to the continuous organic phase of the above mixture produces discontinuous water-in-oil phases. Further addition of water causes inversion of the discontinuous water-in-oil phases to discontinuous oil-in-water phases and forms a suspension or an emulsified liquid in which the above mixture is suspended as particles (droplets) in the aqueous medium (hereinafter, this method is referred to as “phase inversion emulsification”). In phase inversion emulsification, water is added in such a manner that the ratio of the amount of water to the total amount of the organic solvent and water added is 30% to 70%, more preferably 35% to 65%, and particularly preferably 40% to 60%. The aqueous medium used is preferably water and more preferably deionized water.

The polyester resin is preferably an acidic group-containing polyester resin. Preferably, the polyester resin is converted into a self-water dispersible resin by neutralizing the acidic groups. The acid value of the self-water dispersible polyester resin is preferably in the range of 1 to 20 mg KOH/g. The acidic groups of the self-water dispersible resin are neutralized with a basic neutralizer to form anionic groups. This increases the hydrophilicity of the resin. The resulting resin (anionic self-water dispersible polyester resin) can be stably dispersed in an aqueous medium without a dispersion stabilizer or a surfactant. Examples of the acidic group include acidic groups, such as a carboxyl group, a sulfonic acid group, and phosphoric acid group. Among these, a carboxyl group is preferred in view of charge properties of the toner. Non-limiting examples of the basic compound used for neutralization include inorganic bases such as sodium hydroxide, potassium hydroxide, and ammonia; and organic bases such as diethylamine, triethylamine, and isopropylamine. Among these, the bases, such as ammonia, sodium hydroxide, and potassium hydroxide, are preferred. To disperse the polyester resin in an aqueous medium, there is a method in which a dispersion stabilizer, such as a suspension stabilizer or a surfactant, is incorporated thereto. However, in the method for forming an emulsion by addition of the suspension stabilizer or the surfactant, high shearing force is needed. Such an emulsion system is not preferred because of the formation of coarse particles and a broad particle size distribution. Therefore, preferably, the self-water dispersible resin is used, and the acidic groups of the resin is neutralized with the basic compound.

Examples of a method for neutralizing the acidic groups (carboxyl groups) with the base include (1) a method including producing a mixture of an acidic group-containing polyester resin, a colorant, a wax, and an organic solvent and then neutralizing the resin with a base; and (2) a method including incorporating a basic neutralizer in an aqueous medium in advance and neutralizing the acidic groups of the polyester resin in the mixture during phase inversion emulsification. Methods of phase inversion emulsification include (A) an emulsifying method including adding the mixture to an aqueous medium; and (B) an emulsifying method including adding an aqueous medium to the mixture. A combination of the method (1) and method (B) achieves a narrow particle size distribution, which is preferred.

In phase inversion emulsification, examples of high-shear emulsification apparatuses and continuous emulsification apparatuses that can be used include a Homomixer (produced by Tokushu Kika Kogyo Co., Ltd.), a Slasher (produced by Mitsui Mining Co., Ltd.), a Cavitron (produced by Eurotec, Ltd.), a Microfluidizer (produced by Mizuho Kogyo Co., Ltd.), a Munton-Golin Homogenizer (produced by Golin Co.), a Nanomizer (produced by Nanomizer Co., Ltd.), and a Static Mixer (produced by Noritake Company). However, for example, a stirrer, an anchor blade, a turbine blade, a faudler blade, a full-zone blade, a max blend blade, a semicircular blade, or the like disclosed in JP-A-9-114135 is preferably used rather than the use of the above-described high-shear emulsification apparatuses. Among these, a large blade, such as the full-zone blade or the max blend blade, capable of uniformly stirring a mixture is more preferred. In an emulsification step (phase inversion emulsification step) of forming fine particles of the mixture in an aqueous medium, the peripheral speed of the stirring blade is preferably in the range of 0.2 to 10 m/s. A method of adding dropwise water under low-shear stirring at a peripheral speed from 0.2 to less than 8 m/s is more preferred. Most preferably, the peripheral speed is in the range of 0.2 to 6 m/s. A peripheral speed of the stirring blade exceeding 10 m/s increases the particle size in a dispersion formed during phase inversion emulsification, which is not preferred. A peripheral speed of less than 0.2 m/s results in nonuniform stirring to cause nonuniform phase inversion. As a result, coarse particles are readily formed, which is not preferred. The temperature during phase inversion emulsification is not particularly limited. Higher temperatures increase the number of coarse particles, which is not preferred. Excessively low temperatures increase the viscosity of the mixture containing the polyester resin and the organic solvent to increase the number of coarse particles, which is not preferred. The temperature during phase inversion emulsification is preferably in the range of 10° C. to 40° C. and more preferably 20° C. to 30° C.

Phase inversion emulsification is performed with the self-water dispersible resin under low shear to inhibit the formation of a fine powder and coarse particles. Thus, in the subsequent coalescence step, aggregates of fine particles having a uniform particle size distribution are easily formed. In the case where a polyester resin not having self-water dispersibility or phase inversion emulsification is performed under high shear, the particle size distribution of the toner particles is broaden because of the formation of coarse particles and the formation of a fine powder composed of the low-molecular-weight component in the resin. Furthermore, the particles composed of the low-molecular-weight component are removed by screening in the following step, thereby disadvantageously degrading the low-temperature fixation properties of the toner. The use of the self-water dispersible resin and the performance of phase inversion emulsification under low shear eliminate the problems.

The 50% volume-average particle size is preferably in the range of above 1 μm and 6 μm or less and more preferably above 1 μm and 4 μm or less. At a 50% volume-average particle size of 1 μm or less, in the case where the colorant and the releasing agent are used, they are insufficiently encapsulated in the polyester resin to adversely affect on charge properties and development properties, which is not preferred. A large particle size limits the particle size of the resulting toner. Thus, the particle size of the fine particles formed in this step needs to be smaller than a target particle size of the toner. A particle size of more than 6 μm is not preferred because coarse particles are easily formed. In the particle size distribution of the fine particles formed in the first step, the content of a volume particle size of 10 μm or more is 2% or less and preferably 1% or less. The content of a volume particle size of 5 μm or more is 10% or less and preferably 6% or less.

In a second step, the resulting fine particles obtained in-the first step coalesce to form aggregates of the fine particles, thereby forming toner particles having a target particle size. In the second step, the amount of a solvent, temperature, types and amounts of a dispersion stabilizer and an electrolyte, stirring conditions, and the like are appropriately controlled to obtain target aggregates. A method for producing aggregates by forming fine particles by emulsion polymerization, aggregating the resulting fine particles, and fusing the aggregated particles by heating, is widely known. Unlike the above-described method including two steps: the aggregating step and the fusing step, the production method (production method by coalescence) according to an aspect of the invention includes a single step of simultaneously performing aggregation and fusion to form aggregates. The method is characterized in that spherical or substantially spherical particles can be obtained without heating.

In the second step, the resulting fine particle dispersion obtained in the first step is diluted with water to adjust the amount of the solvent. A dispersion stabilizer is added thereto. An aqueous electrolyte solution is added dropwise thereto in the presence of the dispersion stabilizer to allow coalescence to proceed, thereby forming aggregates having a predetermined particle size. The fine particles formed from the self-water dispersible resin in the first step are stably dispersed in an aqueous medium owing to the effect of the electric double layer composed of a carboxylic acid salt. In the second step, the fine particles are destabilized by adding an electrolyte capable of destroying or reducing the electric double layer in the aqueous medium containing the fine particles dispersed therein.

Examples of the electrolyte include acidic materials, such as hydrochloric acid, sulfuric acid, phosphoric acid, acetic acid, and oxalic acid. Furthermore, a water-soluble organic or inorganic salt, such as sodium sulfate, ammonium sulfate, potassium sulfate, magnesium sulfate, sodium phosphate, sodium dihydrogenphosphate, sodium chloride, potassium chloride, ammonium chloride, calcium chloride, or sodium acetate, may be effectively used. These electrolytes used for coalescence may be used alone or in combination. Among these, a sulfate of a monovalent cation, e.g., sodium sulfate or ammonium sulfate, is preferred in view of uniform coalescence. The resulting fine particles obtained in the first step are swollen with the solvent and are unstable because of the electric double layer shrunk by addition of the electrolyte. Hence, a collision of particles with each other even under low-shear stirring facilitates coalescence.

However, the addition of the electrolyte alone results in nonuniform coalescence due to the unstable dispersion of the fine particles in the system, thus forming coarse particles and aggregates. The aggregates of the fine particles formed by addition of the electrolyte and the acidic material may coalesce repeatedly to form aggregates each having a particle size of a target particle size or more. To prevent this, an inorganic dispersion stabilizer such as hydroxyapatite or an ionic or a nonionic surfactant needs to be added as a dispersion stabilizer before the addition of the electrolyte and the like. The dispersion stabilizer used needs to have the property to retain dispersion stability even in the presence of the electrolyte to be added. Examples of the dispersion stabilizer having the property include nonionic emulsifiers, such as polyoxyethylenenonyl phenyl ether, polyoxyethyleneoctyl phenyl ether, polyoxyethylenedodecyl phenyl ether, polyoxyethylene alkyl ether, polyoxyethylene fatty acid ester, sorbitan fatty acid ester, polyoxyethylene sorbitan fatty acid ester, Pluronic; anionic emulsifiers such as alkyl sulfates; and cationic dispersion stabilizers such as quaternary ammonium salts. Among these, an anionic or nonionic dispersion stabilizer is preferred because even a small amount of the dispersion stabilizer can stabilize the dispersion system. The clouding point of the nonionic surfactant is preferably 40° C. or more. These surfactants may be used alone or in combination. The addition of the electrolyte in the presence of the dispersion stabilizer (emulsifier) enables nonuniform coalescence to be inhibited, thereby obtaining a narrow particle size distribution and increasing the yield.

Stirring conditions during coalescence is important to achieve uniform coalescence. For example, a stirrer, an anchor blade, a turbine blade, a faudler blade, a full-zone blade, a max blend blade, a cone cape blade, a helical blade, a double helical blade, or a semicircular blade disclosed in JP-A-9-114135 is appropriately selected and used. Among these, a large blade, such as the full-zone blade or the max blend blade, capable of uniformly stirring a mixture is more preferred. The fine particles swollen with the solvent collide with each other under stirring and coalesce to form aggregates. Thus, the use of a high-shear apparatus, such as a Homomixer, including a stator and a rotor or the use of a stirring blade, such as a turbine blade, that locally applies high shear and has a low ability to uniformly stir the entirety of a medium results in nonuniform coalescence, leading to the formation of coarse particles. Thus, with respect to the stirring conditions, the peripheral speed is preferably in the range of 0.2 to 10 m/s, more preferably from 0.2 to less than 8 m/s, and particularly preferably 0.2 to 6 m/s. A peripheral speed exceeding 10 m/s results in nonuniform coalescence to easily form coarse particles, which is not preferred. A peripheral speed of less than 0.2 m/s results in nonuniform coalescence due to the lack of a shear force for stirring to easily form coarse particles, which is not preferred. Only the collision between the fine particles facilitates coalescence. The resulting aggregates subjected to coalescence are not dissociated and dispersed again. Therefore, a small number of ultrafine particles and a narrow particle size distribution are achieved, thus improving the yield.

In the second step, if necessary, the resulting fine-particle dispersion obtained by phase inversion emulsification in the first step is preferably diluted with water. The dispersion stabilizer and the electrolyte are successively added thereto to perform coalescence. Alternatively, the solvent content of the dispersion is preferably adjusted by addition of the dispersion stabilizer and/or the electrolyte to obtain particles each having a target particle size. The solvent content of the system after the addition of the electrolyte is preferably in the range of 5 to 25 mass %, more preferably 5 to 20 mass %, and particularly preferably 5 to 18 mass %. A solvent content of less than 5 mass % increases the amount of the electrolyte required for coalescence, which is not preferred. A solvent content exceeding 25 mass % increases the amount of aggregates due to nonuniform coalescence and the amount of the dispersion stabilizer added, which is not preferred.

The shape of the toner particles after coalescence can be controlled by adjusting the solvent content. When the solvent content is in the range of 13 to 25 mass %, spherical to substantially spherical fine particles are easily formed by coalescence because of a large degree of swelling of the fine particles with the solvent. When the solvent content is in the range of 5 to 13 mass %, modified to substantially spherical particles are easily formed because of a small degree of swelling of the fine particles with the solvent.

The content of the dispersion stabilizer used is preferably in the range of 0.5 to 3.0 mass %, more preferably 0.5 to 2.5 mass %, and particularly preferably 1.0 to 2.5 mass % relative to the solid content of the fine particles. At a dispersion stabilizer content of less than 0.5 mass %, the intended effect of preventing the formation of coarse particles is not exerted. At a dispersion stabilizer content exceeding 3.0 mass %, even when the electrolyte content is increased, coalescence does not proceed sufficiently. Thus, particles each having a predetermined particle size are not formed. As a result, the fine particles are left to reduce the yield, which is not preferred.

The content of the electrolyte used is preferably in the range of 0.5 to 15 mass %, more preferably 1 to 12 mass %, and particularly preferably 1 to 10 mass % relative to the solid content of the fine particles. At an electrolyte content of less than 0.5 mass %, coalescence does not proceed sufficiently, which is not preferred. An electrolyte content exceeding 15 mass % results in nonuniform coalescence to reduce the yield due to the formation of aggregates and coarse particles, which is not preferred.

The temperature during coalescence is preferably in the range of 10° C. to 50° C., more preferably 20° C. to 40° C., and particularly preferably 20° C. to 35° C. At a temperature less than 10° C., coalescence does not easily proceed, which is not preferred. At a temperature exceeding 50° C., the rate of coalescence is increased, thereby easily forming aggregates and coarse particles, which is not preferred. Therefore, it is possible to form aggregates by coalescence at a low temperature in the range of 20° C. to 40° C.

In the first and second steps, various embodiments may be made. Preferred embodiments are as follows: (1) a method in which in the first step, the fine particles are produced from the resin solution containing the polyester resin, the colorant, and, if necessary, the releasing agent and charge control agent, and then the second step (coalescence step) is performed; (2) a method in which in the first step, the fine particles are produced from the resin solution containing the polyester resin, the colorant, and, if necessary, the releasing agent, the charge-control-agent dispersion is mixed thereto, and then the second step (coalescence step) is performed; (3) a method in which in the first step, the fine particles composed of the polyester resin are produced, at least one of the colorant dispersion and, if necessary, the releasing-agent dispersion and the charge-control-agent dispersion is separately prepared, they are mixed, and then the second step (coalescence step) is performed; (4) a method in which in the first step, the fine particles are produced from the resin solution of the polyester resin and the releasing agent, the colorant dispersion and, if necessary, the charge-control-agent dispersion are added thereto, and then the second step (coalescence step) is performed.

These dispersions, such as the colorant dispersion, the charge-control-agent dispersion, and the releasing-agent dispersion, may be prepared as follows: For example, each of the agents is mixed with a nonionic surfactant such as polyoxyethylenealkyl phenyl ether, an anionic surfactant, such as an alkyl benzene sulfonate or an alkyl sulfate, or a cationic surfactant such as a quaternary ammonium salt in water, and then the mixture is mechanically pulverized with grinding media to prepare a corresponding one of the dispersions. Alternatively, the dispersion can be prepared as described above in the presence of the basic neutralizer, except that the self-water dispersible polyester resin is used in place of the surfactant. With respect to the colorants the releasing agent, and the charge control agent used here, each of them may be melt-kneaded with the polyester resin in advance. In this case, since resin adsorbs the materials, the degree of exposure of the materials at surfaces of the particles is reduced to impart desirable properties in charge properties and development properties.

To retain satisfactory triboelectrification properties, it is effective to prevent the colorant and the like from being exposed at surfaces of the base toner particles, i.e., it is effective to attain a toner structure in which the colorant and the like are encapsulated in the base toner particles. The degradation of charge properties as a reduction in the particle size of the toner is also caused by the fact that the colorant and other additives, such as wax in general, are partially exposed at the surfaces of the base toner particles. Even if the colorant content (mass %) is the same, the surface area of the base toner particles is increased by the reduction in particle size. Furthermore, rates of the colorant, wax, and the like exposed at the surfaces of the base toner particles are increased. As a result, the composition of the surfaces of the base toner particles markedly changes, and the triboelectrification properties of the base toner particles markedly change, thereby making it difficult to obtain proper charge properties.

In the base toner particles, the colorant, the wax, and the like are preferably encapsulated in the binder resin. This encapsulation structure provides a satisfactory printed image. To actively encapsulate the colorant and the releasing agent in the base resin, the method (1) or the method (2) is preferably employed. It can be easily determined, for example, by observing the cross section of the particles with a transmission electron microscope (TEM) that the colorant and wax are not exposed at the surfaces of the base toner particles. Specifically, the base toner particles are embedded in a resin and cut with a microtome. The resulting cross section is optionally stained with ruthenium oxide or the like. TEM observation demonstrates that the pigment and wax are included in the binder resin and dispersed in the particles almost uniformly. Furthermore, the method (2) is preferred in order to localize the charge control agent on the surfaces of the toner particles to exert the function thereof.

The shape of the aggregates of the fine particles obtained in the second step can be changed from an irregular shape to spherical shape in accordance with the degree of coalescence. For example, the average circularity can be changed between 0.94 and 0.99. The average circularity can also be determined by taking a scanning electron microscope (SEM) photograph of the toner particles obtained by drying the aggregates of the fine particles, followed by measurements and calculations. However, the average circularity is more easily determined with a flow type particle image analyzer FPIA-1000 produced by Toa Iyo Denshi Co., Ltd.

A third step will be described below. The resulting aggregate slurry of the fine particles obtained in the second step is filtered through a wet vibration screen to remove foreign matter such as resin pieces and coarse particles. Solid-liquid separation may be performed by the known method with a centrifuge, a filter press, a belt filter, or the like. The organic solvent is removed by vacuum distillation of the slurry. Alternatively, the organic solvent is removed by washing and dehydrating the slurry. Water is removed by centrifugal dehydration.

In an aspect of the invention, from the viewpoint of the external-additive particles serving as a drying aid in a fourth step described below and of the adhesiveness of the external-additive particles added when the negatively chargeable toner is formed, the degree of vacuum distillation or the number of washing and dehydration is preferably controlled in such a manner that the content of the organic solvent (on a mass basis), such as methyl ethyl ketone, in the base toner particles is 200 to 1,000 ppm and preferably 200 to 800 ppm. The residual solvent content is calculated from peak areas obtained by gas chromatography.

A residual solvent content of less than 200 ppm reduces the adhesiveness of the external-additive particles on the base toner particles, thus degrading durability. At an excessively high residual solvent content, a large amount of the solvent is left after the base toner particles are dried, thereby resulting in failure in an odor and in other steps. Furthermore, durability is disadvantageously degraded.

In the fourth step described below, from the standpoint of the adhesiveness of the external-additive particles serving as the drying aid, the water content of the base toner particles is preferably in the range of 20 to 40 mass % by controlling a period of time for centrifugal dehydration. The water content of the swollen base toner particles refers to the ratio of the weight of water to the total weight (sum of the weight of anhydrous toner and the weight of water). In an aspect of the invention, the water content is defined as a value measured by weight loss on heating at 105° C.

When the water content of the base toner particles exceeds 40 mass %, in the subsequent fourth step, drying requires time, and the external-additive particles are easily embedded; hence, the effect of the fine particles added is not easily exerted. Thus, the amount of the fine particles added needs to increase. However, an increase in the amount added is not preferred because fixation in a printer is inhibited. A water content of less than 20 mass % locally causes blocking, thereby disadvantageously deforming the substantially spherical base toner particles and increasing the number of agglomerates. In particular, when the base toner particles each have a core-shell structure, disadvantageously, the shell structure is easily destroyed. A small water content increases free coarse particles, leading to the nonuniformity of the toner properties. That is, the effect of the fine particles added is not easily obtained.

In the fourth step, 0.1 to 3.0 mass % of the external-additive fine particles having an average particle size of 30 to 50 nm are added to the base toner particles having a predetermined residual solvent content and a predetermined water content. As a result, the external-additive fine particles are uniformly attached on surfaces of the wet fine particles. Thus, blocking is effectively prevented.

In an aspect of the invention, preferably, some of the external-additive particles used in the subsequent step are added as the drying aid to the wet base toner particles before drying. As the external-additive particles suitable as the drying aid, fine silica particles having an average particle size of 30 to 50 nm and subjected to hydrophobization are preferred, and RX50 manufactured by Nippon Aerosil Co., Ltd. is exemplified. Furthermore, fine titania particles, fine alumina particles, and the like having an average particle size of 30 to 50 nm and subjected to hydrophobization are exemplified.

when the fine particles as the drying aid has a particle size of less than 30 nm, the fine particles are embedded in the wet base particles. This is not preferred because the intended effect is not exerted. At a particle size exceeding 50 nm, many particles are required to be uniformly attached to the surfaces of the wet base particles, which is not preferred. The fine particles as the drying aid are preferably added in an amount of 0.1 to 3.0 mass % and preferably 0.2 to 2.0 mass % relative to the base toner particles. The fine particles each having a smaller particle size need to be added in a relatively small amount. The fine particles each having a larger particle size are need to be added in a relatively large amount. An excessively small amount added is not preferred because the intended effect is not exerted. An excessively large amount added causes detachment in drying and increases the number of free fine particles. The free fine particles are left in a drying apparatus, leading to the nonuniformity of the negatively chargeable toner.

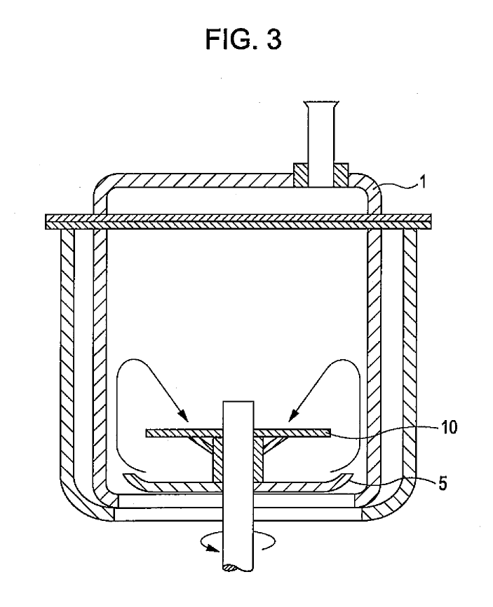

With respect to a method for adding the external-additive particles serving as the drying aid for the wet base particles before drying, the external-additive particles serving as the drying aid are preferably mixed in any of a spherical mixer shown in FIG. 1 and a Henschel mixer shown in FIG. 3 at a shearing force smaller than that in the spherical mixer used in a method for adding the external additive described below.

Preferably, a drying method includes stirring powder with a vacuum stirring dryer, such as a Ribocone (manufactured by Okawara Mfg. Co., Ltd.) or a Nauta mixer, under reduced pressure while heating to a temperature at which the base toner particles are not thermally fused or aggregated. Drying is preferably performed in such a manner that the water content of the base toner particles after drying is 0.5 mass % or less. Examples of another drying method include a fluidized-bed dryer (manufactured by Okawara Mfg. Co., Ltd.) and a vibration dryer (manufactured by Chuo Kakohki Co., Ltd.).

The toner particles are spherical or substantially spherical. The toner particles preferably have an average circularity of 0.97 or more, thereby improving powder flowability and transfer efficiency. When the shape of the toner particles approaches from a spherical shape to an irregular shape, the particles have poor flowability during addition treatment in a mixer described below. The yield is reduced even when the peripheral speed of the stirring blade is reduced. Furthermore, the amount of positively charged toner particles is increased, thus disadvantageously broadening a charge distribution. When the shape of the toner particles approaches to the spherical shape, it is difficult to uniformly attach the external-additive particles to the base toner particles. Thus, the peripheral speed needs to increase. This causes adhesion to the tip of the blade and the wall of the mixer, thus reducing the yield. Furthermore, free external-additive particles and positively charged toner particles are increased, thereby broadening the charge distribution.

With respect to the particle size distribution of the base toner particles, the ratio of 50% volume particle size to 50% number particle size as measured by Coulter Multisizer TAII is preferably 1.25 or less and more preferably 1.20 or less. At a ratio of 1.25 or less, a satisfactory image is easily obtained, which is preferred. Furthermore, GSD is preferably 1.30 or less and more preferably 1.25 or less. The term “GSD” refers to a value determined by the square root of (16% volume particle size/84% volume particle size) as measured by Coulter Multisizer TAII. A lower GSD value results in a narrower particle size distribution, thereby providing a satisfactory image.

The volume-average particle size of the base toner particles is preferably in the range of 1 to 13 μm in view of the resulting image quality and the like, and is more preferably in the range of about 3 to 10 μm because good matching with a currently existing machine is easily obtained. In the case of a color toner, the volume-average particle size is preferably in the range of about 3 to 8 μm. A smaller volume-average particle size improves definition and gradation and reduces the thickness of the toner layer for forming the printed image, thereby producing the effect of reducing the amount of the toner to be consumed per page, which is preferable.

The synthesis example and physical properties of the polyester resin and the synthesis example of the base toner particles will be described below. The term “part” means a mass part, and the term “water” means deionized water, unless otherwise specified.

### Synthesis Example of Polyester Resin

In a separable flask, terephthalic acid (TPA) and isophthalic acid (IPA) as the divalent carboxylic acid, polyoxypropylene(2.4)-2,2-bis(4-hydroxyphenyl)propane (BPA-PO) and polyoxyethylene(2.4)-2,2-bis(4-hydroxyphenyl)propane (BPA-EO) as the aromatic diol, ethylene glycol (EG) as the aliphatic diol, and trimethylolpropane (TMP) as the aliphatic triol were placed in each molar ratio shown in Table 1, and 0.3 mass % of tetrabutyltitanate as the polymerization catalyst was placed thereto relative to the total amount of the monomers. The flask was equipped with a thermometer, a stirrer, a condenser, and a nitrogen introducing tube at the upper portion. The mixture was reacted in an electrically heated mantle heater at 220° C. for 15 hours in a nitrogen gas flow at normal pressure. After gradual evacuation, the reaction was continued at 10 mmHg. The reaction was monitored by measuring the softening point in accordance with the ASTM.E28-517 standard. The reaction was completed by terminating the evacuation when the softening point reached a predetermined temperature. The reaction was completed by terminating the evacuation when the softening point reached a predetermined temperature. The composition and values of the physical properties (values of properties) of the resin thus synthesized are shown in Table 1.

TABLE 1

| | | | Resin | |
|---|---|---|---|---|
| | | | R1 | R2 |
| Resin composition | TPA | | 36.9 | 35.8 |
| | IPA | | 9.2 | 12.2 |
| | BPA-EO | | 11.3 | — |
| | BPA-PO | | 22.5 | 22 |
| | EG | | 20.1 | 27 |
| | TMP | | — | 3 |
| | Total | | 100 mol % | 100 mol % |
| Resin properties | Gel content (mass %) | | 0 | 4 |
| | FT value | Tfb | 88 | 133 |
| | | T ½ | 98 | 159 |
| | | T end | 107 | 175 |
| | GPC | Mw | 5,600 | 78,000 |
| | | Mw/Mn | 2.7 | 25.8 |
| | | >600,000 | 0 | 3 |
| | | <10,000 | 100 | 42 |

| | | |
|---|---|---|
| DSC Tg (° C.) | 55 | 65 |
| Acid value KOH mg/g | 6.7 | 10 |

| | | |
|---|---|---|
| Type of resin | Linear | Crosslinked |

In Table 1,
>600,000: the area ratio of a component having a molecular weight of 600,000 or more.
<10,000: the area ratio of a component having a molecular weight of 10,000
TPA: terephthalic acid
IPA: isophthalic acid
BPA-PO: polyoxypropylene(2.4)-2,2-bis(4-hydroxyphenyl)propane
BPA-EO: polyoxyethylene(2.4)-2,2-bis′(4-hydroxyphenyl)propane
EG: ethylene glycol
TMP: trimethylolpropane
FT value: value measured by flow tester

In Table 1, the term “T1/2 temperature” means a value measured with a nozzle having a diameter of 1.0 mm and a length of 1.0 mm at a load of 10 kg per unit area (cm²) and a heating speed of 6° C./min with a flow tester (CFT-500, produced by Shimadzu Corporation). The term “glass transition temperature Tg” means a value measured at a heating rate of 10° C./min by the second-run method with a differential scanning calorimeter (DSC-50, produced by Shimadzu Corporation).

### Preparation Example of Releasing Agent Dispersion

First, 50 parts of carnauba wax (Carnauba wax No. 1, product imported by Kato Yoko) and 50 parts of a polyester resin (R1 in Table 1) were kneaded with a pressure kneader. The kneaded mixture and 185 parts of methyl ethyl ketone were placed in a ball mill. After stirring for 6 hours, the mixture was removed. The solid content was adjusted to 20% by mass to obtain releasing agent microdispersion (W1).

### Preparation of Colorant Masterchip and Preparation Example of Colorant Dispersion

According to the composition shown in Table 2, a color pigment and a resin were kneaded in a ratio by weight of 50/50 to produce a colorant masterchip P. The color pigment and the resin were kneaded with a twin roll. The resulting kneaded mixture P and methyl ethyl ketone were placed in a ball mill in such a manner that the solid content was 40 mass %. After stirring for 36 hours, the mixture was removed. The solid content was adjusted to 20 mass % to obtain a colorant dispersion.

TABLE 2

| Colorant masterchip | P |
|---|---|
| Colorant | Cyan |
| Resin | R1 |
| Colorant/resin | 50/50 |

The colorant shown in Table 2 is described below.

Cyan pigment: Fastogen Blue TGR (produced by Dainippon Ink and Chemicals, Inc.)

### Preparation of Wet-Kneaded Mill Base

The releasing dispersion, the colorant dispersion, the dilution resin (additional resin), and methyl ethyl ketone were mixed with a despa. The solid content was adjusted to 55% to obtain a mill base (MB). The composition of the mill base is shown in Table 3.

TABLE 3

| | | Dilution | | | |
|---|---|---|---|---|---|
| | | resin | Wax dispersion | | |
| MII | Colorant | (additional | (amount of | Ratio of | Solid |
| base | masterchip | resin) | resin) | resin | content |
| MB | P 30 parts | R1/R2 = | W1 50 parts | R1/R2 = | 55% |
| | (R1 3 parts) | 28.8/55.2 | (R1 5 parts) | 40/60 | |
| | | (parts) | | | |

Properties of the resin mixture shown in Table 3 are shown in Table 4. The resin particles passing through 200 mesh were mixed in the ratio by weight, and the properties were measured.

TABLE 4

| | | | R1/R2 |
|---|---|---|---|
| | | | 40/60 |
| Resin properties | Gel content (mass %) | | 2.1 |
| | FT value | Tfb | 112 |
| | | T ½ | 140 |
| | | T end | 154 |
| | GPC | Mw | 52,000 |
| | | Mw/Mn | 21.2 |
| | | >600,000 | 2 |
| | | <10,000 | 62 |

| | |
|---|---|
| DSC Tg (° C.) | 58 |
| Acid value KOH mg/g | 8.7 |

In Table 4,
>600,000: the area ratio of a component having a molecular weight of 600,000 or more.
<10,000: the area ratio of a component having a molecular weight of 10,000

### Production of Base Toner Particles

In a 2-L cylindrical separable flask provided with a max-blend blade as a stirrer blade, 545.5 parts of the mill base MB and 23.8 parts of 1N aqueous ammonia were placed. The mixture was sufficiently stirred at 350 rpm with a ThreeOne Moter. Then, 133 parts of deionized water was added thereto. The resulting mixture was further stirred. The temperature of the mixture was set at 30° C. Under the same conditions, 133 parts of deionized water was added dropwise to form a fine particles dispersion by phase inversion emulsification. In this case, the peripheral speed of the stirring blade was 1.19 m/s. Then, 333 part of deionized water was added thereto to adjust the solvent content.

Next, 4.1 parts of Epan 450 (produced by Dai-Ichi Kogyo Seiyaku Co., Ltd.) as a nonionic emulsifier was diluted with water and added thereto. The temperature of the mixture was set at 30° C. The number of revolutions was set at 250 rpm. Then, 410 parts of 3% aqueous ammonium sulfate solution was added dropwise thereto to adjust the solvent content of the dispersion to 15.5 mass %. Under the same conditions, the stirring was continued for 70 minutes to complete coalescence. In this case, the peripheral speed was 0.85 m/s.

As the third step in a production process, the residual solvent content of the resulting slurry was adjusted by controlling a period of time for vacuum distillation or the number of washing and dehydration to form a slurry having the residual solvent content described below. The resulting slurries were used in Examples and Comparative Examples. The content of methyl ethyl ketone was calculated from peak areas obtained by gas chromatography. That is, the slurry having a methyl ethyl ketone content of 210 ppm was used in Example 1. The slurry having a methyl ethyl ketone content of 300 ppm was used in Example 2. The slurry having a methyl ethyl ketone content of 280 ppm was used in Example 3. The slurry having a methyl ethyl ketone content of 250 ppm was used in Example 4. The slurry having a methyl ethyl ketone content of 550 ppm was used in Example 5. The slurry having a methyl ethyl ketone content of 700 ppm was used in Example 6. The slurry having a methyl ethyl ketone content of 1,100 ppm was used in Comparative Example 1. The slurry having a methyl ethyl ketone content of 150 ppm was used in Comparative Example 2.

By adjusting the dehydration time in centrifugation, the water content of the cake was set at 38 mass % in each of Examples and Comparative Examples. The water content is determined by weight loss on heating at 105° C.

As will be described in Examples, external-additive particles serving as a drying aid were added. The resulting mixture was dried at 45° C. with a Ribocone dryer (manufactured by Okawara Mfg. Co., Ltd.) in such a manner that the water content was 0.5 mass % or less.

Tables 5 to 7 shows the properties of the base toner particles used in Example 1. The same is true in other Examples and Comparative Examples.

TABLE 5

| | Initial dispersion diameter after phase inversion | | |
|---|---|---|---|
| | | | Volume % of |
| Mill base | Dv50 (μm) | Volume % of 10 μm or more | 5 μm or more |
| MB1 | 1.54 | 0.84 | 5.37 |

TABLE 6
Toner particle properties

| | | | Number % of | Volume % of |
|---|---|---|---|---|
| Dv50 (μm) | Dv50/Dn50 | GSD | 3 μm or less | 10 μm or more |
| 6.8 | 1.07 | 1.15 | 1.5 | 1.2 |

TABLE 7

| Average circularity | Yield (%) |
|---|---|
| 0.985 | Pass |

In Tables, the particle size and the particle size distribution were measured with a 100 μm aperture tube of a Coulter Multisizer II. The term “Dv50” means a 50% volume-average particle size. The term “Dv50/Dn50” means the ratio of the 50% volume-average particle size to the 50% number-average particle size. The term “GSD” means a value determined by the square root of (16% volume particle size/84% volume particle size).

The average circularity was measured with a flow type particle image analyzer FPIA-1000 produced by Toa Iyo Denshi Co., Ltd.

The yield was determined as follows: the solvent in the resulting dispersion of the base toner particles was removed. The mixture passed through a 530-mesh screen. The yield was calculated by means of the following formula:

Yield (%)={(solid content of mill base fed)−(solid content of residue on screen)}×100/(solid content of mill base fed),

the base toner particles having a yield of 90% to 100% were expressed as “Pass”.

The external-additive particles will be described below. In an aspect of the invention, the number-average primary particle size that specifies the external additive was determined as follows: the external additive was dispersed in isopropyl alcohol. A droplet thereof was dropped on a measurement sample stage and dried. The fine particles on the sample stage were observed by a SEM at ×100,000 magnification. Then, particle sizes of 500 of the fine particles observed in a SEM image were actually measured with S-4800 (manufactured by Hitachi Technologies Co., Ltd.).

Examples of the hydrophobic fine silica particles (1) include hydrophobic fine silica particles having a negatively chargeable number-average primary particle size of 7 to 60 nm and preferably 10 to 50 nm and prepared by vapor-phase oxidation (dry method) of halogenized silicon compound. The total amount of the fine silica particles (1) added is 0.5 to 5.0 mass parts and preferably 0.7 to 3.0 mass parts per 100 mass parts of the base toner particles. in the case where 0.1 to 3.0 mass % of the hydrophobic fine silica particles having a particle size of 30 to 50 nm have been added as the drying aid, the fine silica particles each having a particle size of, for example, 10 to 30 nm are preferably added in a first external addition step of multiple external addition steps in such a manner that the amount of added is equal to the total amount added including the amount of the drying aid.

A smaller number-average primary particle size of the negatively chargeable fine silica particles increases the flowability of the resulting toner. A number-average primary particle size of less than 7 nm may cause the fine silica particles to be embedded in the base toner particles. A number-average primary particle size exceeding 60 nm may degrade the flowability.

Examples of the negatively chargeable fine silica particles include RX50 (number-average primary particle size: 32 nm) and RX200 (number-average primary particle size: 12 nm) manufactured by Nippon Aerosil Co., Ltd.

(2) Negatively chargeable hydrophobic spherical fine silica particles having a number-average primary particle size of 100 to 600 nm and preferably 100 to 300 nm are fine silica particles each having a large particle size. The spherical fine silica particles are monodisperse, i.e., a standard deviation is D50*0.22 or less with respect to the average particle size including aggregates. The sphericity of Wadell is 0.6 or more and preferably 0.8 or more. The monodisperse spherical fine silica particles are prepared by a sol-gel method as a wet process and have a specific gravity of 1.3 to 2.1. The large-sized silica (2) is added in an amount of 0.2 to 2.0 mass parts and preferably 0.3 to 1.5 mass parts per 100 mass parts of the base toner particles.

At an average particle size of less than 100 nm, the fine silica particles each having a small particle size are embedded in the base toner particles. Thereby, the flowability and charge stability cannot be retained. Furthermore, the spacer effect is not exerted. At an average particle size exceeding 600 nm, the silica particles are not easily attached to the base toner particles and are easily detached from the surfaces of the base toner particles.

Examples of the (2) hydrophobic negatively chargeable fine silica particles include Seahostar KEP10 (number-average primary particle size: 140 nm) and Seahostar KE-P30 (number-average primary particle size: 280 nm) (manufactured by Nippon Shokubai Co., Ltd).

The ratio (by mass) of addition of the (2) large-sized silica to (1) small-sized silica is preferably 1:3 to 3:1 and preferably 1:2.8 to 2.8:1 and is preferred in view of imparting flowability to the toner and prolonged charge stability. The large-sized silica and the small-sized silica may be simultaneously added to the base toner particles in the production of the negatively chargeable single-component toner. The large-sized silica and the small-sized silica are added in an amount of 1.0 to 2.5 mass parts and preferably 1.5 to 2.3 mass parts in total relative to 100 mass parts of the base toner particles in view of the mixing ratio thereof.

The (1) and (2) fine silica particles are preferably subjected to hydrophobic treatment. The hydrophobization of the surfaces of the fine silica particles further improves the flowability and charge properties of the toner. The fine silica particles are hydrophobized by a method, such as a wet process or a dry process, that is generally used by a person skilled in the art with a hydrophobizing agent selected from silane compounds, such as aminosilane, hexamethyldisilazane, and dimethyldichlorosilane; and silicone oils, such as dimethyl silicone, methylphenyl silicone, fluorine-modified silicone oil, alkyl-modified silicone oil, amino-modified silicone oil, and epoxy-modified silicone oil in response to the charge properties.

Next, (3) hydrophobic fine titanium oxide particles having a number-average primary particle size of 10 to 40 nm have relatively low electric resistivity. Titanium oxide can have various crystal forms, such as rutile, anatase, and rutile-anatase. In particular, rutile-anatase type titanium oxide has a spindle form and is preferably used in view that the electric charge is easily adjusted and that the titanium oxide particles are not easily embedded in the base toner particles even when the number of printed sheets in increased. The fine titanium particles are added in an amount of 0.2 to 2.0 mass parts and preferably 0.3 to 1.5 mass parts per 100 mass parts of the base toner particles.

The hydrophobicity of surfaces of the fine titanium oxide particles reduces a change in charge properties (i.e., the stability of the charge properties is retained) due to the change of the external environment of the toner and improves the flowability of the toner, which is preferred. The hydrophobization of the fine titanium oxide particles is performed as in the case of the hydrophobization of the negatively chargeable fine silica particles. An example of the hydrophobic, rutile-anatase type fine titanium oxide particles is STT-30S (number-average primary particle size: 35 nm) (manufactured by Titan Kogyo K.K).

Next, (4) fine α-alumina particles having a number-average primary particle size of 100 to 600 nm and preferably 100 to 300 nm are industrially produced by firing aluminum hydroxide in air to form α-alumina, i.e., by the Bayer process, the aluminum hydroxide being prepared by treating a bauxite material with sodium hydroxide. The fine α-alumina particles have irregular shapes. Thus, the fine α-alumina particles are externally added to the base toner particles to dig the external additive embedded in the base toner particles due to the use of the regulated materials, thereby imparting stable flowability and charge properties. An excessively large number-average primary particle size reduces the adhesion to the base toner particles, which is not preferred.

Examples of the fine α-alumina particles include AKP50 (number-average primary particle size: 190 nm) and AKP30 (number-average primary particle size: 410 nm) (manufactured by Sumitomo Chemical Co., Ltd).

The content of the fine α-alumina particles is 0.05 to 1.3 mass parts and preferably 0.1 to 1.0 mass parts per 100 mass parts of the base toner particles. At a content of less than 0.05 mass parts, the function as a spacer is not exerted. At a content exceeding 1.3 mass parts, the amount of free large-sized alumina particles is increased, which is not preferred.

Metallic soap particles will be described below. The metallic soap particles reduce the ratio of the free external additives, such as the large-sized silica particles and the fine α-alumina particles, and inhibit the occurrence of fogging. Furthermore, the metallic soap particles function as a lubricant and thus protect a photoreceptor (OPC) from an abrasive effect of alumina particles and the like, thereby prolonging a lifetime. The metallic soap particles are composed of a metal salt selected from higher fatty acid salts of zinc, magnesium, calcium, and aluminum. Examples thereof include magnesium stearate, calcium stearate, zinc stearate, aluminum monostearate, and aluminum tristearate. The metallic soap particles have a number-average primary particle size of 0.1 to 1.5 μm and preferably 0.5 to 1.3 μm.

The amount of the metallic soap particles added is 0.05 to 0.5 mass parts and preferably 0.1 to 0.3 mass parts per 100 mass parts of the base toner particles. When the amount is less than 0.05 mass parts, the functions as a lubricant and a binder are insufficient. When the amount exceeds 0.5 mass parts, fogging tends to increase. Furthermore, the amount of the metallic soap particles added is 2 to 10 mass parts per 100 mass parts of the external additive. When the amount is less than 2 mass parts, no effect as a lubricant or a binder is exerted. An amount exceeding 10 mass parts leads to a reduction in flowability and an increase in fogging, which is not preferred.

In the case where non-contact development is performed, continuous printing for a long period results in an excessively high negative charge of the toner, thereby reducing the amount of toner used for development and reducing printed image density. However, in the subsequent treatment, mixing the positively chargeable fine silica particles inhibits excessive charge and prevents a reduction in image density.

The positively chargeable fine silica particles have a number-average primary particle size of 20 nm to 40 nm. The positively chargeable fine silica particles are preferably subjected to hydrophobization because the change in charge properties in response of the change in external environment (i.e., the charge properties are stably retained) and the flowability of the toner is improved. The positively chargeable fine silica particles are hydrophobized with an aminosilane coupling agent, an amino-modified silicone oil, or the like. The positively chargeable fine silica particles are added in an amount of 0.1 to 1.0 mass part and preferably 0.2 to 0.8 mass parts per 100 mass parts of the base toner particles.

Examples of the hydrophobic positively chargeable fine silica particles include commercially available NA50H (manufactured by Nippon Aerosil Co., Ltd.) and TGB20F (manufactured by Cabot).

(3) The hydrophobic fine titanium oxide particles, (4) the fine α-alumina particles, and (5) the metallic soap particles are preferably added to the base toner particles after (1) the hydrophobic negatively chargeable fine silica particles and (2) the hydrophobic negatively chargeable fine silica particles are added to the base toner particles.

The negatively chargeable single-component toner according to an aspect of the invention may further include another external additive other than the above-described external additives without departing from the scope of the invention. Examples thereof include inorganic fine particles such as fine particles of metal oxides, e.g., strontium oxide, tin oxide, zirconium oxide, magnesium oxide, and indium oxide; fine particles of nitrides, e.g., silicon nitride; fine particles of carbides, e.g., silicon carbide; fine particles of metal salts, e.g., calcium sulfate, barium sulfate, and calcium carbonate;. and inorganic fine particles of composites thereof; and resin fine particles.

With respect to the subsequent treatment, in the second step, at least the hydrophobic fine titanium oxide particles and the fine α-alumina particles are preferably added and mixed. The metallic soap particles and the positively chargeable fine silica particles are preferably added in the final step in view of the object of the addition.

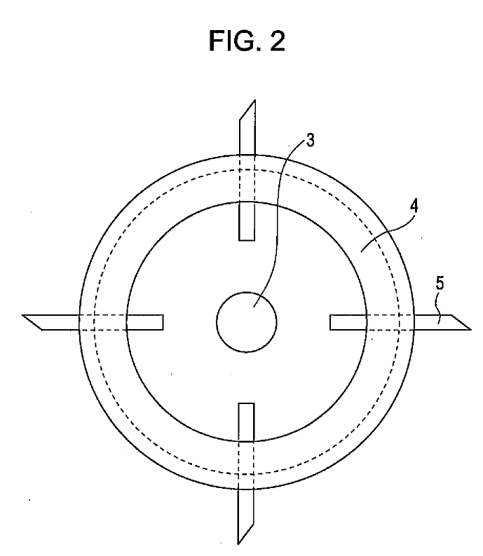

According to an aspect of the invention, a step of mixing the base toner particles and the external-additive particles will be described below. The mixing treatment of the base toner particles and the external-additive particles is performed with a spherical mixer shown in FIGS. 1 and 2. FIG. 1 is a cross sectional view through the center. FIG. 2 is a plan view of an example of a mixing blade. Figures show a spherical mixer 1, a horizontal circular-disk bottom 2, a driving shaft 3, a doughnut-shaped circular disk 4, a stirring blade 5, an air-seal hole 6, a cylinder 7, a flange 8, a jacket 9, and a stirring blade 11.

As shown in figure, the spherical mixer 1 includes the horizontal circular-disk bottom 2, the driving shaft 3 passing through the center of the horizontal circular-disk bottom 2, the driving shaft 3 being provided with the stirring blade 11 having a cone cross-section, and a plurality of stirring blades 5. The stirring blade 11 is a turbine blade that can mix a mixture at a relatively low shear. Furthermore, for the purpose of reinforcement, the doughnut-shaped circular disk 4 is attached to the top of the stirring blade 5.

The cylinder 7 passing through the top of the spherical mixer 1 is disposed in such a manner that the inner end of the cylinder 7 is located in the upper hemisphere, the top being an extension of the driving shaft 3. Seal air is exhausted from the cylinder 7. The upper hemisphere of the spherical mixer 1 can be opened from the flange 8 located at the middle portion. The upper hemisphere is opened, and particles are fed. A centrifugal force generated by the rotation of the stirring blade 11 moves the particles along the inner surface of the spherical mixer l in a spiral manner (not shown). The particles are ejected upward as indicated by the arrows in FIG. 1 to reach the top. The particles are dropped due to a reduction in motion energy. The particles slip off the upper cone surface. Then, the stirring blade 5 is resupplied with the particles. The degree of mixing is increased by repetition of this step. An outlet (not shown) for the particles that have been subjected to external-addition treatment is disposed at the bottom of the spherical mixer 1. Furthermore, the spherical mixer 1 is provided with the water-cooling jacket 9. The content can be cooled by passing cooling water having a temperature described below at a flow rate described below.

The driving shaft 3 is rotatably provided with the stirring blade 11 through the air-seal hole 6. The stirring blade 5 is located in such a manner that tips of the stirring blade 5 are positioned between the perimeter of the doughnut-shaped circular disk 4 and the inner surface of the spherical mixer 1, as shown in FIGS. 1 and 2. The lower edge of the stirring blade 5 is in the form of an arc along the inner surface of the spherical mixer 1 as shown in FIG. 1. The stirring blade 5 has a structure such that the rotation thereof ejects the particles along the inner surface of the spherical mixer and toward the top of the spherical mixer. The air-seal hole 6 functions as a air-supplying hole to prevent the particles from entering the driving shaft portion. Air supplied is exhausted through the cylinder 7.

From the standpoint of uniform treatment of the particles and the exhaust property of air supplied, the length of the cylinder 7 in the vessel is 1/20 or more and preferably ⅓ or more of the length between the doughnut-shaped circular disk 4 and the top of the vessel. The upper limit is preferably a length to the extent that the end of the cylinder 7 is not in contact with the particles which are allowed to stand. Furthermore, the cylinder 7 need not have the cylindrical shape but may have a structure in which seal air is exhausted therethrough. For example, the cylinder 7 may have a structure including a slit.

The ratio of the diameter of the horizontal circular-disk bottom 2 to the diameter of the spherical mixer 1 may be 0.25 to 0.80. The ratio of the external diameter of the doughnut-shaped circular disk 4 to the diameter of the horizontal circular-disk bottom 2 may be 0.50 to 1.20. The ratio of the diameter of the stirring blade 5 to the diameter of the spherical mixer 1 may be 0.50 to 0.90. Furthermore, the ratio of the internal diameter of the doughnut-shaped circular disk 4 to the external diameter thereof is 0.5 to 0.95 and preferably 0.7 to 0.8. Furthermore, the ratio of the amount of the particles fed to the spherical mixer to the volume of the spherical mixer is 0.1 to 0.9 and preferably 0.3 to 0.5.

Unlike a Henschel mixer shown in FIG. 3, the spherical mixer does not allow the particles to steeply arise. The spherical mixer allows the base toner particles and the external-additive particles to flow along the curved inner surface of the vessel at a high speed. Furthermore, the distance of the inner surface along which the particles flow is long, thus allowing the base toner particles to easily roll and achieving uniform external-additive treatment for a short period of time. Moreover, the particles are moved to the top of the spherical mixer and then returned to the stirring blade at the bottom; hence, the vertical movement depending on the attraction of gravity is more vigorous compared with a cylindrical vessel, such as a Henschel mixer. Furthermore, the spherical mixer advantageously eliminates the need for an upper blade. When aggregates of the external-additive particles are strong, projections are made in the vessel to generate turbulent flow, thereby disintegrating the aggregates.

When the base toner particles and a plurality of external-additive particles having different average particle sizes are mixed, multiple-step mixing can be performed. A short mixing time results in insufficient mixing. At a long mixing time, the particles adhere to the inner surface of the vessel and the stirring blade to reduce the yield. The mixing time in each step needs to be in the range of 0.5 to 10 minutes and preferably 1 to 5 minutes. To inhibit the increase in temperature, the treatment in each step may be performed in several batches. Furthermore, from the same viewpoint, the peripheral speed (π× outermost diameter of blade×number of rotation/time) of the tip of the stirring blade in the spherical mixer is in the range of 10 m/s to 100 m/s.

In the case of the external-additive treatment for the base toner particles, after the spherical mixer is charged with the base toner particles, the large-sized silica particles and the small-sized silica particles are fed as the first step. The external-additive treatment is performed, and the rotation is terminated. The titanium oxide particles and the fine α-alumina particles are added thereto as the second step. The external-additive treatment is performed, and the rotation is terminated. The positively chargeable silica particles and the metallic soap particles are added thereto as the third (final) step. The external-additive treatment is performed. Such a process is preferred.

The toner produced according to an aspect of the invention can be applied to an image-forming apparatus using single-component toner described in JP-A-2002-202622 and an image-forming apparatus using two-component toner. Furthermore, the toner produced according to an aspect of the invention can be applied to a contact development-type image-forming apparatus and a non-contact development-type image-forming apparatus. Preferably, the toner produced according to an aspect of the invention can be applied to single-component, non-magnetic color toner. According to an aspect of the invention, there is provided negatively chargeable toner suitable for a non-contact development-type image-forming apparatus.

### EXAMPLES

An aspect of the invention will be described in detail below by Examples.

### Example 1

A Henschel mixer (Henschel, 20 L, blade shape: YiA0) shown in FIG. 3 was charged with 3.0 kg of the base toner particles produced above and having a residual solvent content of 210 ppm, and then 0.5 mass parts of negatively chargeable fine silica particles {RX50, manufactured by Nippon Aerosil Co., Ltd., number-average primary particle size: 32 nm) was added thereto. The resulting mixture was mixed at a peripheral speed of 10 m/s for 5 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 36 g of negatively chargeable fine silica particles {RX200, manufactured by Nippon Aerosil Co., Ltd., number-average primary particle size: 12 nm) and 9 g of Seahostar KEP10 (manufactured by Nippon Shokubai Co., Ltd., number-average primary particle size: 140 nm) were added thereto.

The spherical mixer had a volume of 20 L. The length of the cylinder 7 in the vessel was 1/11 of the height from the doughnut-shaped circular disk 4. The ratio of the diameter of the horizontal circular-disk bottom 2 to the diameter of the spherical mixer l was 0.57. The ratio of the external diameter of the doughnut-shaped circular disk 4 to the diameter of the horizontal circular-disk bottom 2 was 1.10. The ratio of the diameter of the stirring blade (turbine blade) 5 to the diameter of the spherical mixer 1 was 0.75. The ratio of the internal diameter of the doughnut-shaped circular disk 4 to the external diameter of the doughnut-shaped circular disk 4 was 0.73. The mixture was mixed for 2 minutes at a peripheral speed of the turbine blade of 50 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 6 g of AKP50 (manufactured by Sumitomo Chemical Co., Ltd., number-average primary particle size: 190 nm) were added thereto. The mixture was mixed for 2 minutes at a peripheral speed of the turbine blade of 50 m/s and a flow rate of seal air of 1.0 Nm³/h.

After the termination of mixing, as the third external-additive treatment step, 9 g of positively chargeable silica particles (NA50H, manufactured by Nippon Aerosil Co., Ltd., number-average primary particle size: 40 nm) and 3 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 50 m/s and a flow rate of seal air of 1.0 Nm³/h.

A cartridge of a color printer (LP9000C, manufactured by Seiko Epson Corporation) was filled with the resulting toner. A solid pattern was printed at a development voltage of 200 V. The concentration of the solid pattern (OD value, Xlite measurement), the amount of toner on the surface of a development roller (DR), i.e., the amount of +toner (number %), and the amount of charge (standard deviation of Q/m) were measured with Espart analyzer (manufactured by Hosokawa Micron Corporation). Furthermore, endurance printing was continuously performed at 5% printing to print 6,000 sheets (25° C., 50% RH), and then the nonuniformity in the solid pattern was visually checked to evaluate durability. Evaluation criteria are as follows: No nonuniformity was observed: Pass, and nonuniformity was observed: failure. Table 8 shows the results.

### Example 2

A Henschel mixer (Henschel, 20 L, blade shape: YIA0) shown in FIG. 3 was charged with 3.0 kg of the base toner particles produced above and having a residual solvent content of 300 ppm, and then 0.7 mass parts of negatively chargeable fine silica particles {RX50, manufactured by Nippon Aerosil Co., Ltd., number-average primary particle size: 32 nm) was added thereto. The resulting mixture was mixed at a peripheral speed of 10 m/s for 5 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 30 g of negatively chargeable fine silica particles {RX200, manufactured by Nippon Aerosil Co., Ltd., number-average primary particle size: 12 nm) and 12 g of Seahostar KEP10 (manufactured by Nippon Shokubai Co., Ltd., number-average primary particle size: 140 nm) were added thereto. The mixture was mixed for 2 minutes at a peripheral speed of the turbine blade of 55 m/s and a flow rate of seal air of 1.0 Nm³/h in the spherical mixer.

After the termination of mixing, as the second external-additive treatment step, 10 g of STT-30S (manufactured by Titan Kogyo K.K., number-average primary particle size: 35 nm) was added thereto. The mixture was mixed for 2 minutes at a peripheral speed of the turbine blade of 55 m/s and a flow rate of seal air of 1.0 Nm³/h.

After the termination of mixing, as the third external-additive treatment step, 8 g of positively chargeable silica particles (NA50H, manufactured by Nippon Aerosil Co., Ltd., number-average primary particle size: 40 nm) and 3 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 55 m/s and a flow rate of seal air of 1.0 Nm³/h.

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 8 shows the results.

### Example 3

A Henschel mixer (Henschel, 20 L, blade shape: YIAO) shown in FIG. 3 was charged with 3.0 kg of the base toner particles produced above and having a residual solvent content of 280 ppm, and then 0.3 mass parts of negatively chargeable fine silica particles {RX50, manufactured by Nippon Aerosil Co., Ltd., number-average primary particle size: 32 nm) was added thereto. The resulting mixture was mixed at a peripheral speed of 10 m/s for 5 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 36 g of negatively chargeable fine silica particles {RX200, manufactured by Nippon Aerosil Co., Ltd., number-average primary particle size: 12 nm) was added thereto. The mixture was mixed for 2 minutes at a peripheral speed of the turbine blade of 45 m/s and a flow rate of seal air of 1.0 Nm³/h in the spherical mixer.

After the termination of mixing, as the second external-additive treatment step, 14 g of STT-30S (manufactured by Titan Kogyo K.K., number-average primary particle size: 35 nm) and 12 g of AKP50 (manufactured by Sumitomo Chemical Co., Ltd., number-average primary particle size: 190 nm) were added thereto. The mixture was mixed for 2 minutes at a peripheral speed of the turbine blade of 45 m/s and a flow rate of seal air of 1.0 Nm³/h.

After the termination of mixing, as the third external-additive treatment step, 9 g of positively chargeable silica particles (NA50H, manufactured by Nippon Aerosil Co., Ltd., number-average primary particle size: 40 nm) and 3 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 45 m/s and a flow rate of seal air of 1.0 Nm³/h.

In the same way as in Example 1, the concentration of the solid pattern (OD value, Xlite measurement), the amount of toner on the surface of a development roller. (DR), i.e., the amount of +toner (number %), the amount of charge (standard deviation of Q/m), and durability were evaluated. Table 8 shows the results.

### Example 4

A spherical mixer (Q type, 20 L, blade shape: turbine, manufactured by Mitsui Mining Company, Limited) shown in FIG. 1 was charged with 3.0 kg of the base toner particles produced above and having a residual solvent content of 250 ppm, and then 1.5 mass parts of negatively chargeable fine silica particles {RX50, manufactured by Nippon Aerosil Co., Ltd., number-average primary particle size: 32 nm) was added thereto. The resulting mixture was mixed at a peripheral speed of 20 m/s for 3 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 28 g of negatively chargeable fine silica particles {RX200, manufactured by Nippon Aerosil Co., Ltd., number-average primary particle size: 12 nm) and 6 g of Seahostar KEP10 (manufactured by Nippon Shokubai Co., Ltd., number-average primary particle size: 140 nm) were added thereto. The mixture was mixed for 2 minutes at a peripheral speed of the turbine blade of 50 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 3 g of AKP50 (manufactured by Sumitomo Chemical Co., Ltd., number-average primary particle size: 190 nm) were added thereto. The mixture was mixed for 2 minutes at a peripheral speed of the turbine blade of 50 m/s and a flow rate of seal air of 1.0 Nm³/h.

After the termination of mixing, as the third external-additive treatment step, 8 g of positively chargeable silica particles (NA50H, manufactured by Nippon Aerosil Co., Ltd., number-average primary particle size: 40 nm) and 2 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 50 m/s and a flow rate of seal air of 1.0 Nm³/h,

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 3 shows the results.

### Example 5

A spherical mixer (Q type, 20 L, blade shape: turbine, manufactured by Mitsui Mining Company, Limited) shown in FIG. 1 was charged with 3.0 kg of the base toner particles produced above and having a residual solvent content of 550 ppm, and then 2.0 mass parts of negatively chargeable fine silica particles {RX50, manufactured by Nippon Aerosil Co., Ltd., number-average primary particle size: 32 nm) was added thereto. The resulting mixture was mixed at a peripheral speed of 20 m/s for 3 minutes.

After mixing, the mixture was placed in a Ribocone dryer (manufactured by okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 38 g of negatively chargeable fine silica particles {RX200, manufactured by Nippon Aerosil Co., Ltd., number-average primary particle size: 12 nm) and 12 g of Seahostar KEP10 (manufactured by Nippon Shokubai Co., Ltd., number-average primary particle size: 140 nm) were added thereto. The mixture was mixed for 2 minutes at a peripheral speed of the turbine blade of 55 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 9 g of AKP50 (manufactured by Sumitomo Chemical Co., Ltd., number-average primary particle size: 190 nm) were added thereto. The mixture was mixed for 2 minutes at a peripheral speed of the turbine blade of 55 m/s and a flow rate of seal air of 1.0 Nm³/h.

After the termination of mixing, as the third external-additive treatment step, 9 g of positively chargeable silica particles (NA50H, manufactured by Nippon Aerosil Co., Ltd., number-average primary particle size: 40 nm) and 2 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 55 m/s and a flow rate of seal air of 1.0 Nm³/h.

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 8 shows the results.

### Example 6

A spherical mixer (Q type, 20 L, blade shape: turbine, manufactured by Mitsui Mining Company, Limited) shown in FIG. I was charged with 3.0 kg of the base toner particles produced above and having a residual solvent content of 700 ppm, and then 1.0 mass parts of negatively chargeable fine silica particles {RX50, manufactured by Nippon Aerosil Co., Ltd., number-average primary particle size: 32 nm) was added thereto. The resulting mixture was mixed at a peripheral speed of 20 m/s for 3 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 36 g of negatively chargeable fine silica particles {RX200, manufactured by Nippon Aerosil Co., Ltd., number-average primary particle size: 12 nm) and 15 g of Seahostar KEP30 (manufactured by Nippon Shokubai Co., Ltd., number-average primary particle size: 280 nm) were added thereto. The mixture was mixed for 2 minutes at a peripheral speed of the turbine blade of 55 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 12 g of AKP30 (manufactured by Sumitomo Chemical Co., Ltd., number-average primary particle size: 410 nm) were added thereto. The mixture was mixed for 2 minutes at a peripheral speed of the turbine blade of 55 m/s and a flow rate of seal air of 1.0 Nm³/h.

After the termination of mixing, as the third external-additive treatment step, 7 g of positively chargeable silica particles (NA50H, manufactured by Nippon Aerosil Co., Ltd., number-average primary particle size: 40 nm) and 2 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 55 m/s and a flow rate of seal air of 1.0 Nm³/h.

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 8 shows the results.

### Comparative Example 1

A Henschel mixer (Henschel, 20 L, blade shape: YiA0) shown in FIG. 3 was charged with 3.0 kg of the base toner particles produced above and having a residual solvent content of 1,100 ppm, and then 0.5 mass parts of negatively chargeable fine silica particles {RX50, manufactured by Nippon Aerosil Co., Ltd., number-average primary particle size: 32 nm) was added thereto. The resulting mixture was mixed at a peripheral speed of 10 m/s for 5 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 80 ppm or less. After drying, agglomerates occurred, and flowability was reduced.

A spherical mixer (Q type, 20 L, blade shape: turbine, manufactured by Mitsui Mining Company, Limited) shown in FIG. 1 was charged with 3.0 kg of the dry base toner particles. Then, 36 g of negatively chargeable fine silica particles {RX200, manufactured by Nippon Aerosil Co., Ltd., number-average primary particle size: 12 nm) and 9 g of Seahostar KEP10 (manufactured by Nippon Shokubai Co., Ltd., number-average primary particle size: 140 nm) were added thereto. The mixture was mixed for 2 minutes at a peripheral speed of the turbine blade of 50 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 6 g of AKP50 (manufactured by Sumitomo Chemical Co., Ltd., number-average primary particle size: 190 nm) were added thereto. The mixture was mixed for 2 minutes at a peripheral speed of the turbine blade of 45 m/s and a flow rate of seal air of 1.0 Nm³/h.

After the termination of mixing, as the third external-additive treatment step, 9 g of positively chargeable silica particles (NA50H, manufactured by Nippon Aerosil Co., Ltd., number-average primary particle size: 40 nm) and 3 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 50 m/s and a flow rate of seal air of 1.0 Nm³/h.

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 8 shows the results.

### Comparative Example 2

A spherical mixer (Q type, 20 L, blade shape: turbine, manufactured by Mitsui Mining Company, Limited) shown in FIG. 1 was charged with 3.0 kg of the base toner particles produced above and having a residual solvent content of 150 ppm, and then 3.5 mass parts of negatively chargeable fine silica particles {RX50, manufactured by Nippon Aerosil Co., Ltd., number-average primary particle size: 32 nm) was added thereto. The resulting mixture was mixed at a peripheral speed of 20 m/s for 3 minutes.

After mixing, the mixture was placed in a Ribocone dryer (manufactured by Okawara Mfg. Co., Ltd.). The mixture was dried at 45° C. until the water content was 0.5 mass % or less while the internal temperature was controlled so as not to be 50° C. or more. Thereby, base toner particles were obtained. In this case, the residual MEK content was 20 ppm or less. After drying, there was no a detectable odor of MEK.

A spherical mixer (Q type, 20 L, blade shape: turbine, manufactured by Mitsui Mining Company, Limited) shown in FIG. 1 was charged with 3.0 kg of the dry base toner particles. Then, 36 g of negatively chargeable fine silica particles {RX200, manufactured by Nippon Aerosil Co., Ltd., number-average primary particle size: 12 nm) and 9 g of Seahostar KEP10 (manufactured by Nippon Shokubai Co., Ltd., number-average primary particle size: 140 nm) were added thereto. The mixture was mixed for 2 minutes at a peripheral speed of the turbine blade of 50 m/s and a flow rate of seal air of 1.0 Nm³/h in the spherical mixer.

After the termination of mixing, as the second external-additive treatment step, 12 g of STT-30S (manufactured by Titan Kogyo K.K., number-average primary particle size: 35 nm) and 6 g of AKP50 (manufactured by Sumitomo Chemical Co., Ltd., number-average primary particle size: 190 nm) were added thereto. The mixture was mixed for 2 minutes at a peripheral speed of the turbine blade of 50 m/s and a flow rate of seal air of 1.0 Nm³/h.

After the termination of mixing, as the third external-additive treatment step, 9 g of positively chargeable silica particles (NA50H, manufactured by Nippon Aerosil Co., Ltd., number-average primary particle size: 40 nm) and 3 g of metallic soap particles (magnesium stearate, Elector MM-2, manufactured by NOF Corporation, number-average primary particle size: 1.3 μm) were added thereto. The resulting mixture was mixed for 2 minutes at a peripheral speed of the turbine blade of 50 m/s and a flow rate of seal air of 1.0 Nm³/h.

In the same way as in Example 1, the concentration of the solid pattern (OD value, Xlite measurement), the amount of toner on the surface of a development roller (DR), i.e., the amount of +toner (number %), the amount of charge (standard deviation of Q/m), and durability were evaluated. Table 8 shows the results.

TABLE 8

| | Amount of | | | |
|---|---|---|---|---|
| | positively | | | |
| | charged | Standard | | |
| | toner | deviation of Q/m | OD value | |
| | (number %) | (%) | (DC 200 V) | Durability |
| Example 1 | 3.3 | 9.6 | 1.38 | Pass |
| Example 2 | 4.0 | 10.9 | 1.40 | Pass |
| Example 3 | 3.1 | 12.6 | 1.34 | Pass |
| Example 4 | 2.8 | 10.5 | 1.38 | Pass |
| Example 5 | 3.3 | 9.8 | 1.40 | Pass |
| Example 6 | 3.4 | 11.0 | 1.38 | Pass |
| Comparative | 18.1 | 10.1 | 1.10 | Failure |
| Example 1 | | | | |
| Comparative | 12.0 | 30.5 | 0.98 | Failure |
| Example 2 | | | | |

As is apparent from Table 8, in each of Examples 1 to 6, the negatively chargeable toner having a small amount of the positively charged toner, the narrow charge distribution, the high concentration of printing (ease of jumping), and high durability was provided, as compared with Comparative Examples 1 and 2.

What is claimed is:

1. A method for producing negatively chargeable toner comprising:
adding a plurality of external-additive fine particles to base toner particles in multiple steps with a spherical mixer, the base toner particles being formed by subjecting a mixture containing at least a resin and an organic solvent to phase inverse emulsification in an aqueous medium, coalescing, washing, dehydrating, and drying the resulting particles,
wherein the dry base toner particles have an organic solvent content of 200 to 1,000 ppm, 0.1 to 3.0 mass % of the external-additive fine particles having an average particle size of 30 to 50 nm are added, and the base toner particles have an average degree of circularity of 0.94 to 0.99.
